(19) United States
(12) Patent Application Publication
(10) Pub. No.: US 2004/0025516 A1
(43) Pub. Date: Feb. 12, 2004

(54) Double closed loop thermoelectric heat exchanger

(76) Inventor: John Van Winkle, Walton, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 10/216,072

(22) Filed: Aug. 9, 2002

(51) Int. Cl. B60H 1/32; F25B 27/00; F25B 21/02

(52) U.S. Cl. 62/3.3; 62/3.61; 62/239; 62/323.2

(57) ABSTRACT

A double pass heat exchanger comprising: a first bank of thermoelectric devices that includes at least one thermoelectric device, the thermoelectric devices having cooling surfaces capable of absorbing thermal energy and opposed heating surfaces capable of dissipating thermal energy; a second bank of thermoelectric devices that includes at least one thermoelectric device, the thermoelectric devices having cooling surfaces capable of absorbing thermal energy and opposed heating surfaces capable of dissipating thermal energy; a first block of heat transfer material in concurrent thermal communication with a first fluid conduit and the heating surfaces of the first bank of thermoelectric devices and the heating surfaces of the second bank of thermoelectric devices; and, a second block of heat transfer material in concurrent thermal communication with a second fluid conduit and the cooling surfaces of the first bank of thermoelectric devices and the second bank of thermoelectric devices.

### CROSS REFERENCE TO RELATED APPLICATIONS

The present application is related to U.S. patent application Ser. No. 10/079,052, entitled, “FLUID HEAT EXCHANGER ASSEMBLY”; Ser. No. 10/123,429, entitled, “COOLING SYSTEM FOR A BEVERAGE DISPENSER”; Ser. No. 10/176,382, entitled, “FLUID COOLING APPARATUS FOR A COMBUSTION SYSTEM”.

### BACKGROUND

1. Field of the Invention

The present invention relates to heat exchanger systems and associated methods of use and manufacture. More particularly, the invention is related to double loop heat exchanger systems, utilizing commercially available thermoelectric heat transfer devices that have the capability to concurrently provide heating and cooling on opposing sides of the device.

2. Description of the Related Art

The heating and/or cooling of fluids and solids has been effectuated in a multitude of fashions dating back as far as the origin of the very reasons for such heat transfer. Older pieces of art typically center around heat transfer relating to a solid or fluid by convection and/or conduction and/or by the emission and propagation of energy in the form of rays or waves.

More specifically, in the area of refrigeration, prior art typically centered around mechanical systems having numerous moving parts. Generally, a refrigeration cycle begins when a liquid flows from a high-pressure atmosphere, through an expansion valve and into a low-pressure atmosphere. This low-pressure atmosphere enables a liquid to evaporate, thereby taking heat from the surroundings to provide the required energy of vaporization; a.k.a. the latent heat of vaporization. The surroundings are decreased in thermal energy and the gaseous product is then drawn into a compressor that compresses the gaseous product. The byproduct of this compression is a liquid and a significant amount of heat. This heat is typically drawn away from the compressed liquid through the use of some sort of convection or conduction means.

The convection means typically associated with a refrigeration cycle include an electric fan or some other device which is capable of generating fluid currents of generally ambient air to pass in thermal communication with the compressed liquid conduit. Generally, convection is defined as the heat transfer between a fluid and a solid surface that takes place as a consequence of motion of fluid relative to the solid surface. Is also known that heat may be dissipated to a solid surface via conduction. Generally, conduction is defined as the mode of heat transfer in which energy exchange takes place from a region of high temperature to that of a low temperature by the kinetic motion or direct impact of molecules, as in the case of fluids at rest, and by the drift of electrons, as in the case of metals.

### SUMMARY OF THE INVENTION

The present invention relates to fluid heat exchanger systems and associated methods of use and manufacture. More particularly, the invention is related to double loop heat exchanger systems. The invention may utilize one or more thermoelectric devices manufactured from two ceramic wafers and a series of “P & N” doped semiconductor blocks sandwiched therebetween. The ceramic wafered thermoelectric devices provide concurrent thermal energy absorption and dissipation on the opposing wafers. The thermoelectric devices take advantage of the Peltier effect; a phenomenon which occurs whenever electrical current flows through two dissimilar conductors. Depending upon the flow of the current, the junction of the two conductors will either absorb or dissipate thermal energy. The thermal energy is moved by the charge carriers in the direction of current flow throughout the circuit.

The invention utilizes this movement of thermal energy within the thermoelectric device to create thermal gradients between a target and a corresponding wafer surface. If the target is a fluid, such as water within a conduit, the temperature of the water and the temperature of the cooler surface of the wafer are the points of reference for determining the thermal energy gradient. So long as the mean temperature of the cooler surface is less than that of the target, thermal energy will be drawn from the target and absorbed by the cooler surface, thereby cooling the target. In some applications in which the target is a fluid, it may not be desired that the thermoelectric device come into direct contact with the target which may interfere with the performance of the thermoelectric device. As such, the fluid targets may be contained in a remote reservoir or a remote conduit. In these examples, the thermoelectric device will not necessarily be in direct thermal contact with the fluid, but may be positioned such that thermal energy may be exchanged between an intermediary fluid and eventually brought into contact with the target fluid or object.

In particular, the thermoelectric devices may be positioned in such a manner so as to provide a compact heat exchanger that is connected to potential targets via thermal communication. In an illustrative example, the double closed loop may contain two nonconductive heat transfer liquids having relatively high heat capacity. These liquids, one being a warmer liquid and the other being a cooler liquid are respectively cooled by conduction between the cooler surface of the thermoelectric device, while the warmer liquid is heated by conduction between the warmer surface of the thermoelectric device and the warm fluid conduit. The cooler liquid then flows to an area in thermal communication with a conduction target such as a computer processor. The liquid, being cooler than the surface of the processor in contact with the cooler fluid conduit, is thereby heated from the thermal energy drawn away from the processor. The heated cooler liquid is again brought into thermal communication with the cooler surface of the thermoelectric device where heat from the cooler liquid is again drawn off. On the other side of the process, the warmer liquid is heated by the warmer surface of the thermoelectric device and is thereafter pumped through a radiator or a fluid reservoir. If the liquid is pumped through a radiator, convection occurs between the radiator surface and the warm fluid conduit thereby drawing off heat, or if the liquid is pumped through a fluid reservoir, the conduction between the fluid in the reservoir and the liquid within the conduit cools the warmer fluid conduit, thereby cooling the contained warmer liquid.

Alternatively, the cooler fluid conduit may be heated by coming into contact with a convection target such as a radiator. In this example, the cooler liquid is heated by a convention target being air at a higher temperature that passes within thermal communication of the cooler fluid conduit, thereby heating the cooler fluid conduit. In these examples, thermal communication allows for the exchange of thermal energy between the target and at least one of the cooler fluid conduit and the warmer fluid conduit.

Advantageously, the ceramic wafered thermoelectric devices operate on relatively low power and voltages and are relatively durable. Because the ceramic wafered thermoelectric devices dissipate heat on the side (warming side) of the device opposite that of the cooling side (absorbing heat), the above described exemplary embodiment of the invention utilizes conduction to remove the heat dissipated by the warming side and conduction to dissipate heat from the cooler side.

It is a first aspect of the invention to provide a double pass heat exchanger comprising: a first bank of thermoelectric devices that includes at least one thermoelectric device, the thermoelectric devices having cooling surfaces capable of absorbing thermal energy and opposed heating surfaces capable of dissipating thermal energy; a second bank of thermoelectric devices that includes at least one thermoelectric device, the thermoelectric devices having cooling surfaces capable of absorbing thermal energy and opposed heating surfaces capable of dissipating thermal energy; a first block of heat transfer material in concurrent thermal communication with a first fluid conduit and the heating surfaces of the first bank of thermoelectric devices and the heating surfaces of the second bank of thermoelectric devices; and, a second block of heat transfer material in concurrent thermal communication with a second fluid conduit and the cooling surfaces of the first bank of thermoelectric devices and the second bank of thermoelectric devices.

It is a second aspect of the invention to provide a double pass heat exchanger comprising: a first bank of thermoelectric devices that includes at least one thermoelectric device, the thermoelectric devices having cooling surfaces capable of absorbing thermal energy and opposed heating surfaces capable of dissipating thermal energy; a second bank of thermoelectric devices that includes at least one thermoelectric device, the thermoelectric devices having cooling surfaces capable of absorbing thermal energy and opposed heating surfaces capable of dissipating thermal energy; a first block of heat transfer material in concurrent thermal communication with a first fluid conduit and the cooling surfaces of the first bank of thermoelectric devices and the cooling surfaces of the second bank of thermoelectric devices; a second block of heat transfer material in concurrent thermal communication with a second fluid conduit and the heating surfaces of the first bank of thermoelectric devices; and, a third block of heat transfer material in concurrent thermal communication with the second fluid conduit and the heating surfaces of the second bank of thermoelectric devices.

It is a third aspect of the invention to provide a method of cooling a fluid comprising the steps of: providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy; orienting the heating surfaces of the first bank of thermoelectric devices so as to at least partially face the heating surfaces of the second bank of thermoelectric devices; orienting a first fluid conduit so as to be in concurrent thermal communication with the heating surfaces of the first bank of thermoelectric devices and the heating surfaces of the second bank of thermoelectric devices; orienting a second fluid conduit so as to be in concurrent thermal communication with the cooling surfaces of the first bank of thermoelectric devices and the cooling surfaces of the second bank of thermoelectric devices; directing a first fluid within the first fluid conduit and directing a second fluid within the second fluid conduit; and, activating the first and second banks of thermoelectric devices.

It is a fourth aspect of the invention to provide a method of cooling a solid comprising the steps of: providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy; orienting a first fluid conduit so as to be in concurrent thermal communication with the heating surfaces of the first bank of thermoelectric devices and the heating surfaces of the second bank of thermoelectric devices; orienting a second fluid conduit so as to be in concurrent thermal communication with the cooling surfaces of the first bank of thermoelectric devices and the cooling surfaces of the second bank of thermoelectric devices; pumping a first fluid within the first fluid conduit and pumping a second fluid within the second fluid conduit; activating the first bank of thermoelectric devices and the second bank of thermoelectric devices; and, bringing a solid into thermal communication with the first fluid contained within the first fluid conduit.

It is a fifth aspect of the invention to provide a method of cooling a solid comprising the steps of: providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy; providing a first block of heat transfer material in concurrent thermal communication with a first fluid conduit, the heating surfaces of the first bank of thermoelectric devices and the heating surfaces of the second bank of thermoelectric devices; providing a second block of heat transfer material in concurrent thermal communication with a second fluid conduit and the cooling surfaces of the first bank of thermoelectric devices and the cooling surfaces of the second bank of thermoelectric devices; pumping a first fluid within the first fluid conduit and pumping a second fluid within the second fluid conduit; activating the first bank and the second bank; and, bringing a solid into thermal communication with the first fluid contained within the first fluid conduit.

It is a sixth aspect of the invention to provide a method of cooling a solid comprising the steps of: providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy; providing a first block of heat transfer material in concurrent thermal communication with a first fluid conduit, the heating surfaces of the first bank of thermoelectric devices and the heating surfaces of the second bank of thermoelectric devices; providing a second block of heat transfer material in concurrent thermal communication with a second fluid conduit and the cooling surfaces of the first bank of thermoelectric devices; providing a third block of heat transfer material in concurrent thermal communication with the second fluid conduit and the cooling surfaces of the second bank of thermoelectric devices; pumping a first fluid within the first fluid conduit and pumping a second fluid within the second fluid conduit; activating the first bank and the second bank; and, bringing a solid into thermal communication with the first fluid contained within the first fluid conduit.

It is a seventh aspect of the invention to provide an apparatus for transferring thermal energy in relation to a gas traveling through a gas intake conduit of an engine, the apparatus comprising: a first radiator having a cool fluid inlet and a cool fluid outlet adapted to be mounted to an air intake conduit of an internal combustion engine; a thermoelectric heat exchanger comprising, at least one thermoelectric device concurrently absorbing thermal energy on a first surface and dissipating thermal energy on a second surface, a cool fluid conduit in thermal communication with the first surface of the thermoelectric device, and, a heat sink in thermal communication with the second surface of the thermoelectric device; and, a first pump in fluid communication with at least one of the cool fluid inlet, cool fluid outlet and the cool fluid conduit.

It is an eighth aspect of the invention to provide a method for transferring thermal energy in relation to air traveling through an air intake to an engine, the method comprising the steps of: providing at least one thermoelectric device which is in thermal communication with an air intake conduit, the thermoelectric device having at least two surfaces, concurrently dissipating thermal energy on a warmer surface and absorbing thermal energy on a cooler surface when powered; and, providing power to at least the one thermoelectric device to establish a thermal gradient between air within the air intake conduit and the cooler surface of at least the one thermoelectric device.

It is a ninth aspect of the invention to provide a method for transferring thermal energy from a gas traveling within a gas conduit of a combustion system, the method comprising the steps of: mounting a first radiator in series with a gas conduit; supplying power to at least one thermoelectric device having at least two surfaces, concurrently dissipating thermal energy on a warmer surface and absorbing thermal energy on a cooler surface; directing a cool fluid through the first radiator and into thermal communication with a gas flowing through the gas conduit so as to increase the thermal energy of the cool fluid and decrease the thermal energy of the gas; directing the cool fluid into thermal communication with the cooler surface of the thermoelectric device so as to increase the thermal energy of the cooler surface and decrease the thermal energy of the cool fluid; and, transferring thermal energy from the warmer surface of the thermoelectric device.

It is a tenth aspect of the invention to provide a method of providing a cooled fluid to a compartment area of a vehicle, the method comprising the steps of: providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy; orienting a first fluid conduit so as to be in concurrent thermal communication with the heating surfaces of the first bank of thermoelectric devices and the heating surfaces of the second bank of thermoelectric devices; orienting a second fluid conduit so as to be in concurrent thermal communication with the cooling surfaces of the first bank of thermoelectric devices and the cooling surfaces of the second bank of thermoelectric devices; providing electric current to the first and/or second bank of thermoelectric devices; bringing a first fluid within the first fluid conduit into thermal communication with the heating surfaces of the first bank of thermoelectric devices and second bank of thermoelectric devices, and bringing a second fluid into thermal communication with the cooling surfaces of the first bank of thermoelectric devices and second bank of thermoelectric devices; bringing a cooling fluid into thermal communication with the second fluid after the second fluid has been cooled by the first and second bank of thermoelectric devices; and, directing the cooling fluid into a compartment area of a vehicle.

It is an eleventh aspect of the invention to provide a method of providing a cooled fluid to a compartment area of a vehicle, the method comprising the steps of: providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy; positioning a first block of heat transfer material in concurrent thermal communication with a first fluid conduit and the heating surfaces of the first bank of thermoelectric devices and the heating surfaces of the second bank of thermoelectric devices; positioning a second block of heat transfer material in concurrent thermal communication with a second fluid conduit and the cooling surfaces of the first bank of thermoelectric devices and the second bank of thermoelectric devices; providing electric current to the first and/or second bank of thermoelectric devices; bringing a first fluid within the first fluid conduit into thermal communication with the heating surfaces of the first and second bank of thermoelectric devices, and bringing a second fluid into thermal communication with the cooling surfaces of the first and second bank of thermoelectric devices; bringing a cooling fluid into thermal communication with the second fluid after the second fluid has been cooled by the first and second bank of thermoelectric devices; and, directing the cooling fluid into a compartment area of a vehicle.

It is a twelfth aspect of the invention to provide a method of cooling a fluid comprising the steps of: providing a first bank of thermoelectric devices having cooling surfaces capable of absorbing thermal energy and opposed heating surfaces capable of dissipating thermal energy; positioning a first fluid conduit into thermal communication with the heating surfaces of the first bank of thermoelectric devices; positioning a second fluid conduit within a second heat transfer block into thermal communication with the cooling surfaces of the first bank of thermoelectric devices; providing electric current to the first bank of thermoelectric devices; bringing a first fluid within the first fluid conduit into thermal communication with the heating surfaces of the first bank of thermoelectric devices; and, bringing a second fluid into thermal communication with the cooling surfaces of the first bank of thermoelectric devices.

It is a thirteenth aspect of the invention to provide a method of controlling the temperature of a liquid within a beverage dispenser, comprising the steps of: providing a first bank of thermoelectric devices having cooling surfaces capable of absorbing thermal energy and opposed heating surfaces capable of dissipating thermal energy; orienting a first fluid conduit in thermal communication with a first one of the cooling surfaces of the first bank of thermoelectric devices and heating surfaces of the first bank of thermoelectric devices; orienting a second block of heat transfer material in concurrent thermal communication with a liquid within a beverage dispenser and with the first one of the heating and cooling surfaces of the first bank of thermoelectric devices; providing electric current to the first bank of thermoelectric devices; directing a first fluid within the first fluid conduit into the first block of heat transfer material; directing the first fluid from the first block of heat transfer material to a heat exchanger; and, controlling the electric current provided to the first bank of thermoelectric devices.

It is a fourteenth aspect of the invention to provide a method of controlling the temperature of a liquid within a beverage dispenser, comprising the steps of: providing a first bank of thermoelectric devices having cooling surfaces capable of absorbing thermal energy and opposed heating surfaces capable of dissipating thermal energy; positioning a first block of heat transfer material in concurrent thermal communication with a first fluid conduit and a first one of the cooling and heating surfaces of the first bank of thermoelectric devices; positioning a second block of heat transfer material in concurrent thermal communication with a liquid within a beverage dispenser and with the first one of the heating and cooling surfaces of the first bank of thermoelectric devices; providing electric current to the first bank of thermoelectric devices; directing a first fluid within the first fluid conduit into the first block of heat transfer material; directing the first fluid from the first block of heat transfer material to a heat exchanger; and, controlling the electric current provided to the first bank of thermoelectric devices.

It is a fifteenth aspect of the invention to provide a method of reducing the thermal energy of a fluid entering an engine, comprising the steps of: providing a first bank of thermoelectric devices having cooling surfaces capable of absorbing thermal energy and opposed heating surfaces capable of dissipating thermal energy; positioning a first fluid conduit in thermal communication with the heating surfaces of the first bank of thermoelectric devices; positioning a second fluid conduit in thermal communication with the cooling surfaces of the first bank of thermoelectric devices; providing electric current to the first bank of thermoelectric devices; bringing a first fluid within the first fluid conduit into thermal communication with the heating surfaces of the first bank of thermoelectric devices; and, bringing a second fluid within the second fluid conduit into concurrent thermal communication with the cooling surfaces of the first bank of thermoelectric devices and a target fluid being directed to an engine.

It is a sixteenth aspect of the invention to provide an apparatus for transferring thermal energy in relation to a lubricant of an internal combustion engine, the apparatus comprising: a thermoelectric heat exchanger including, at least one thermoelectric device concurrently absorbing thermal energy on a first surface and dissipating thermal energy on a second surface, a lubricant conduit in thermal communication with the first surface, and a heat sink in thermal communication with the second surface; and, a first pump in fluid communication with the lubricant conduit.

It is a seventeenth aspect of the invention to provide an apparatus for transferring thermal energy in relation to a gas flowing toward a combustion chamber of an internal combustion engine, the apparatus comprising: a thermoelectric heat exchanger including, at least one thermoelectric device concurrently absorbing thermal energy on a first surface and dissipating thermal energy on a second surface, a gas conduit in thermal communication with the first surface, and a heat sink in thermal communication with the second surface; and, a turbocharger in fluid communication with the gas conduit.

It is an eighteenth aspect of the invention to provide an apparatus for transferring thermal energy in relation to a fuel of an internal combustion engine, the apparatus comprising: a thermoelectric heat exchanger including, at least one thermoelectric device concurrently absorbing thermal energy on a first surface and dissipating thermal energy on a second surface, a fuel conduit in thermal communication with one of the first surface and the second surface, and a fluid conduit in thermal communication with one of the second surface and the first surface.

It is a nineteenth aspect of the invention to provide a method of cooling fuel before entering an internal combustion engine, comprising the steps of: activating a thermoelectric heat exchanger having at least one thermoelectric device dissipating thermal energy on a first surface and absorbing thermal energy on a second surface; orienting a fuel conduit so as to be in thermal communication with the first surface of the thermoelectric device; directing fuel through the fuel conduit, thereby decreasing the thermal energy of the fuel; orienting a warm fluid conduit so as to be in thermal communication with the second surface of the thermoelectric device; directing the warm fluid through the warm fluid conduit, thereby increasing the thermal energy of the warm fluid; directing the warm fluid through a conventional heat exchanger so as to reduce the thermal energy of the warm fluid; and, cycling the warm fluid between the conventional heat exchanger and the thermoelectric heat exchanger.

It is a twentieth aspect of the invention to provide a method of heating fuel before entering an internal combustion engine, comprising the steps of: activating a thermoelectric heat exchanger having at least one thermoelectric device dissipating thermal energy on a first surface and absorbing thermal energy on a second surface; positioning a fuel conduit so as to be in thermal communication with the second surface of the thermoelectric device; directing fuel through the fuel conduit, thereby increasing the thermal energy of the fuel; positioning a warm fluid conduit so as to be in thermal communication with the first surface of the thermoelectric device; directing the warm fluid through the warm fluid conduit, thereby decreasing the thermal energy of the warm fluid; directing the warm fluid through a conventional heat exchanger so as to increase the thermal energy of the warm fluid; and, cycling the warm fluid between the conventional heat exchanger and the thermoelectric heat exchanger.

It is a twenty-first aspect of the invention to provide an engine lubricant cooling system for a vehicle comprising: a vehicle engine lubricant conduit; a first block of heat transfer material in thermal communication with the vehicle engine lubricant conduit; a second block of heat transfer material; and, at least one thermoelectric device having a cooling surface that absorbs thermal energy when activated and an opposed heating surface that transmits thermal energy when activated, the thermoelectric device being positioned between the first and second blocks of heat transfer material such that the cooling surface faces and is in thermal communication with the first block of heat transfer material and such that the heating surface faces and is in thermal communication with the second block of heat transfer material.

It is a twenty-second aspect of the invention to provide an engine air stream cooling system for a vehicle comprising: a coolant liquid conduit; a first block of heat transfer material in thermal communication with the coolant liquid conduit; a second block of heat transfer material; at least one thermoelectric device having a cooling surface that absorbs thermal energy when activated and an opposed heating surface that transmits thermal energy when activated, the thermoelectric device being positioned between the first and second blocks of heat transfer material such that the cooling surface faces and is in thermal communication with the first block of heat transfer material and such that the heating surface faces and is in thermal communication with the second block of heat transfer material; and, means for transferring thermal energy from a vehicle engine air stream to the coolant liquid conduit.

It is a twenty-third aspect of the invention to provide a method for cooling an engine lubricant, comprising the steps of: positioning a heat-exchanger assembly in line with a vehicle engine lubricant conduit, the heat-exchanger assembly including, at least a first block of heat transfer material in thermal communication with the vehicle engine lubricant conduit; at least one thermoelectric device having a cooling surface that absorbs thermal energy when activated and an opposed heating surface that transmits thermal energy when activated, the thermoelectric device being positioned such that the cooling surface faces and is in thermal communication with the first block of heat transfer material; and, activating the thermoelectric device such that heat is transferred from engine lubricant flowing through the vehicle engine lubricant conduit and into the cooling surface of the thermoelectric device.

It is a twenty-fourth aspect of the invention to provide a method for cooling an air stream directed into at least one of a vehicle turbo charger and a vehicle engine combustion section, comprising the steps of: providing a heat-exchanger assembly with a vehicle, the heat-exchanger assembly including, a first block of heat transfer material, at least one thermoelectric device having a cooling surface that absorbs thermal energy when activated and an opposed heating surface that transmits thermal energy when activated, the thermoelectric device being positioned such that the cooling surface faces and is in thermal communication with the first block of heat transfer material, and a coolant fluid conduit in thermal communication with the first block of heat transfer material; circulating a coolant fluid through the coolant fluid conduit; transferring thermal energy from an air stream, directed into at least one of a vehicle turbo charger and a vehicle engine combustion section, to the coolant fluid circulating through the coolant fluid conduit; and, activating the thermoelectric device to transfer thermal energy from the coolant fluid circulating through the coolant fluid conduit and into the cooling surface of the thermoelectric device.

### BRIEF DESCRIPTION OF THE DRAWINGS

FIG. 1 is a perspective view of a ceramic wafered thermoelectric device as may be utilized in the exemplary embodiments;

FIG. 2 is a schematic diagram of an exemplary embodiment of the present invention having a closed conductive system;

FIG. 3 is a schematic diagram of another exemplary embodiment of the present invention having an open conductive system;

FIG. 4 is a side profile view of an exemplary application of the present invention;

FIG. 5 is a side profile view of another exemplary application of the present invention;

FIG. 6 is a schematic diagram of another exemplary embodiment of a heat exchanger assembly for use with the present invention;

FIG. 7 is a schematic diagram of another exemplary embodiment of a heat exchanger assembly for use with the present invention;

FIG. 8 is a frontal view of an exemplary embodiment of a heat-exchanging core for use with the present invention;

FIG. 9 is a rear view of an exemplary embodiment of a heat-exchanging core for use with the present invention;

FIG. 10 is an exploded view of an exemplary heat-exchanger for use in an exemplary embodiment of the present invention;

FIG. 11 is a schematic diagram of another exemplary embodiment of the present invention having a dual convective system;

FIG. 12 is a diagram of an exemplary embodiment of the present invention having a dual convective system;

FIG. 13 is a diagram of an exemplary embodiment of the present invention having a dual convective system.

FIG. 14 is a schematic of an exemplary embodiment of the present invention having a dual convective system;

FIG. 15 is an exploded view of an exemplary in-line radiator between downstream and upstream conduit sections;

FIG. 16 is a perspective view of a portion of an exemplary embodiment that includes a radiator, a pump and a fluid reservoir;

FIG. 17 a schematic diagram of another exemplary application of the present invention;

FIG. 18 is a schematic diagram of another exemplary application of the present invention;

FIG. 19 is a schematic diagram of another exemplary embodiment of the present invention having a convective and conductive system;

FIG. 20 is a schematic diagram of another exemplary embodiment of the present invention having a convective and conductive system;

FIG. 21 is an exploded view of an exemplary heat exchanging core to be utilized in an exemplary embodiment of the present invention;

FIG. 22 is a schematic diagram of an exemplary heat exchanging core;

FIG. 23 is a frontal view of an exemplary heat-exchanging core to be utilized in cooling a liquid or solid an exemplary embodiment of the present invention;

FIG. 24 is a is a rear view of an exemplary heat-exchanging core to be utilized in cooling a liquid or solid an exemplary embodiment of the present invention;

FIG. 25 is a schematic diagram of another exemplary embodiment of the present invention having a dual conductive system;

FIG. 26 is a schematic diagram of an exemplary control system for use with an exemplary embodiment of the present invention.

FIG. 27 is a schematic diagram of an exemplary control system as may be utilized in conjunction with the present invention.

### DETAILED DESCRIPTION OF THE PREFERRED EMBODIMENTS

The present invention provides a double loop thermal energy transfer system and method for exchanging thermal energy between a thermoelectric device and a target. The methods and systems described below are exemplary in nature and are not intended to constitute limits upon the present invention.

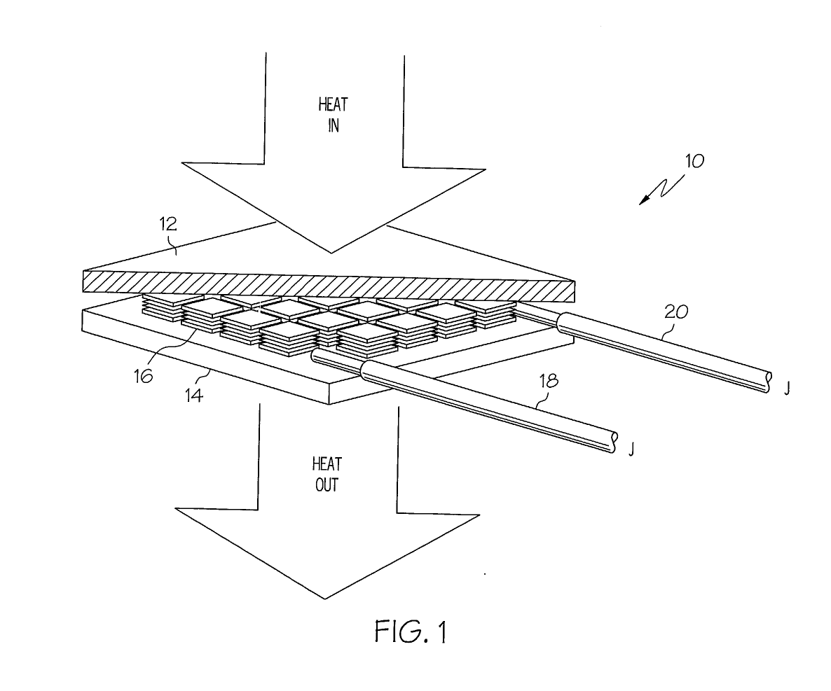

The exemplary embodiments of the present invention utilize commercially-available thermoelectric devices (TEs) and more specifically, ceramic wafered thermoelectric devices (CWTDs) that have opposed ceramic surfaces. Upon activation of the CWTD(s), one of the ceramic surfaces becomes heated while an opposing one of the ceramic surfaces becomes cooled. For example, as shown in FIG. 1, the ceramic wafered thermoelectric devices (CWTDs) 10, in the exemplary embodiments, utilize two thin ceramic wafers 12, 14 with a series of bismuth telluride semi-conductor blocks 16 sandwiched therebetween that are sufficiently doped to exhibit an excess of electrons (P) or a deficiency of electrons (N). The wafer material provides an electrically-insulated and mechanically rigid support structure for the thermoelectric device. The “P & N” type semiconductor blocks are electrically interconnected such that, upon electrical activation, and depending upon the polarity, heat is transferred from one ceramic wafer to the opposite wafer. In sum, this transfer of heat causes one ceramic wafer 12 to become cooled while the opposing ceramic wafer 14 becomes hot. The CWTD(s) 10 are commercially available, for example, from Melcor, of Trenton, N.J. (www.melcor.com) as part no. CP2-12706L.

CWTD 10 has leads 18, 20 which provide direct current in the “J” direction to the device, thereby making one wafer 14 warmer in comparison to the other wafer 12 which is cooler. Upon switching of the leads 18, 20 and directing current in the opposite direction, “-J”, the one wafer 14 now becomes the cooler wafer and the other wafer 12 becomes the warmer wafer. This flexibility enables the opposing wafers 12, 14 of the CWTD 10 to change their character (heating to cooling or cooling to heating) simply by changing the direction of direct current flow. However, the following exemplary embodiments will be explained using the wafer 12 as the cooler wafer, while the other wafer 14 will be referred to as the warmer wafer.

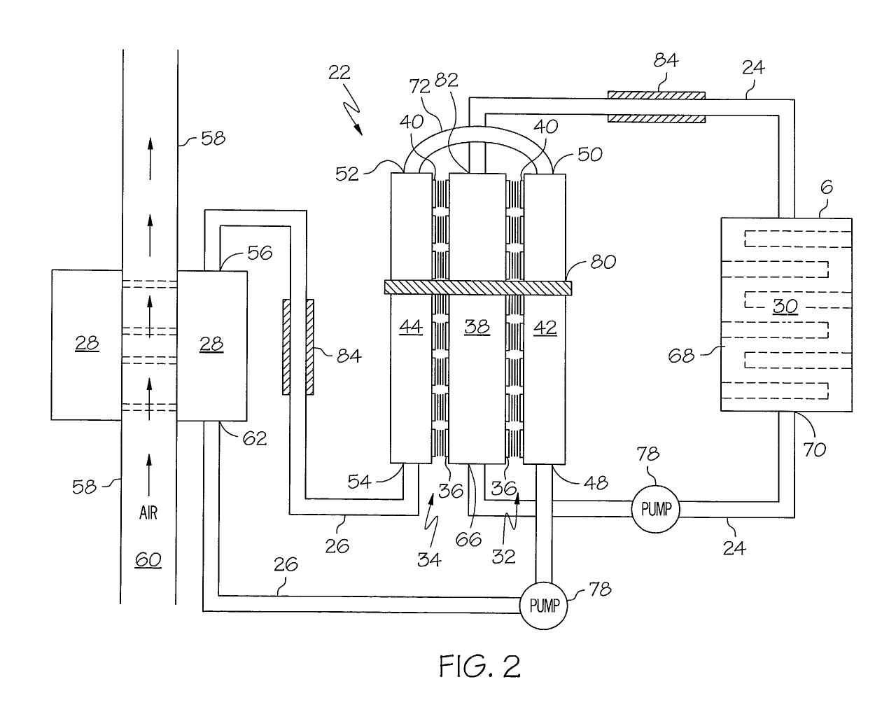

Referencing FIG. 2, an exemplary embodiment of a double loop conduction/convection heat exchange system is shown for cooling air within a structure such as, without limitation, a house, an office building; or within a vehicle such as, without limitation, a boat, a truck, a plane or an automobile. The system includes a heat-exchanging core 22 that is in fluid communication with a warm fluid conduit 24 and a cool fluid conduit 26, while maintaining the segregated nature of the two fluid conduits. The heat-exchanging core 22 is also coupled to a radiator 28 via the cool fluid conduit 26 and coupled to a thermal energy sink 30 via the warm fluid conduit 24. The heat-exchanging core 22 of this exemplary embodiment included three blocks (38, 42, 44) of heat transfer material having fluid conduits passing therethrough. The conduits passing throught the first and third blocks 42, 44 are in fluid communication with the cool fluid conduit 26 and the bridge conduit 72 to form a closed loop with the radiator 28. The conduits passing through the second block 38 are in fluid communication with the warm fluid conduit 24 to form a closed loop with the thermal energy sink 30. A first bank of thermoelectric devices 32 and a second bank of thermoelectric devices 34 are oriented so as have their warmer wafer surfaces 36 in thermal communication with the second block 38, while the cooling wafer surfaces 40 of the first bank 32 are oriented in thermal communication with the first block 42, and the cooling wafer surfaces 40 of the second bank 34 are oriented in thermal communication with the third block 44.

The thermal energy absorbed by the cooler surfaces 40 of the first and second banks 32, 34 of thermoelectric devices is electrically pumped to the opposing warming surfaces 36 of those respective devices 32, 34. In addition to the thermal energy absorbed by the cooling surfaces 40, thermal energy is produced by the CWTDs 10 themselves as a result of the electrical resistance to current flow throughout the device 10. It is desired, in the exemplary embodiments, that the sum of these two thermal energy components be removed so that thermal contamination does not occur between the warming and cooling surfaces 36, 40. Thermal contamination is simply a condition that occurs when the warming surfaces 36 do not dissipate the sum of the thermal energy components, such that thermal energy from the warming surfaces 36 is absorbed by the cooling surfaces 40, effectively short-circuiting the heat transfer cycle of the thermoelectric device 10.

In practice, as the cool fluid (not shown) passes through the entrance 48 of the first block 42, the cool fluid comes into thermal communication with the cooler surfaces 40 of the first bank of thermoelectric devices 32, and thermal energy is transferred from the cool fluid (through the heat transfer material) to the cooler surfaces 40 of the first bank of thermoelectric devices 32 throughout the length of the first block 42. After completing what is generally denoted as the first pass, the cool fluid reaches the exit point 50 of the first block 42, the cool fluid is routed to the entrance 52 of the third block 44 beginning what is hereinafter referred to as the second pass. At the entrance 52 of the third block 44, the entering cool fluid again comes into thermal communication with cooler surfaces 40, however, this time being the second bank of thermoelectric devices 34. Again, as long as the mean temperature of the cooling surfaces 40 is below that of the mean temperature of the cool fluid entering the third segment 44, thermal energy will gravitate toward the cooling surfaces 40 of the first and second banks 32, 34. Any appreciable net loss in thermal energy by the cool fluid while within the third block 44 will result in a further temperature reduction by the cool fluid. When the cool fluid reaches the exit point 54 of the third block 44, it is routed through the cool fluid conduit 26 to the entrance 56 of the radiator 28.

Positioned relative to the ductwork 58 of the structure or vehicle, the radiator 28 provides for thermal communication between the entering cool fluid 46 and the air 60 drawn from the structure or vehicle. Thus, if the air 60 coming into thermal communication with the cool fluid 46 is at a temperature greater than that of the cool fluid, thermal energy will be transferred from the air 60 and absorbed by the cool fluid. Alternatively, the cool fluid will effectively heat the air 60 if the cool fluid temperature remains above that of the air 60. It is to be generally understood that the flow rates of the air 60 and the cool fluid may be varied depending upon a number of factors, among these being whether the cool fluid is a gas or liquid and the relative heat capacity of the cool fluid. Functioning properly in a cooling operation, the air 60 downstream from the radiator 28 should exhibit a decrease in temperature as compared to the upstream air 60, while the cool fluid exiting the radiator 28 should exhibit an increase in thermal energy and preferably an increase in temperature as compared to the cool fluid entering the radiator 28. Concurrently, the cooled air 60 is then directed via the ductwork 58 to defined areas within the structure or vehicle, while cool fluid that passes the exit point 62 of the radiator 28 is directed to the entrance 48 of the first block 42 to begin the first pass.

On the opposite side of the convection cycle is the conduction cycle. Here, a warm fluid (not shown) is routed to the entrance 66 of the second block 38 of the heat-exchanging core 22 and thereby brought into thermal communication concurrently with the warming surfaces 36 of the first and second banks 32, 34 in a unitary pass. Thermal energy dissipated by the warming surfaces 36 is conducted through the heat transfer material of the second block 38 and absorbed by the warm fluid flowing therein. The warm fluid exiting the second block 38 is directed into the warm fluid conduit 24 and thereafter to the thermal energy sink 30. While the volumetric flow rate of the warm fluid may be such that noticeable temperature differences between the second block's 38 entering and exiting fluid may not be appreciable, it is envisioned that operating at such a flow rate may not be desired as it may tend to require a significant amount more of energy to provide such a flow rate. Nevertheless, all flow rates are within the scope of the invention.

As the warm fluid exits the second block 38, it enters the warm fluid conduit 24 and is delivered to a thermal energy sink 30 where the warm fluid is reduced in thermal energy via conduction between the thermal energy sink 30 and its surroundings. In this exemplary embodiment in which the target may be a structure, the warm fluid is pumped through a section of tubing 68 that is run in a loop to a depth of 100 feet underground. The temperature of the earth surrounding the tubing 68 ideally should be below that of the warm fluid, and the tubing 68 may be buried to a depth appropriate to achieve the desired temperature differential. As the warm fluid flows through the tubing 68, thermal energy is conducted through the tubing 68 and transferred throughout the earth. The warm fluid that emerges from the end 70 of the buried tubing 68, being diminished in thermal energy, is thereafter cycled to the entrance 66 of the second block 38 of the heat-exchanging core 22. The tubing may alternatively be run in a serpentine pattern buried at a relatively uniform depth such as 6 feet underground, or other depth known by one skilled in the art to achieve the desired thermal energy transfer.

The heat-exchanging core 22 of this exemplary embodiment may comprise aluminum blocks 42, 38 and 44, that are machined so as to exhibit a circular interior cross-section while concurrently exhibiting a quadrilateral outer cross-section. These blocks 42, 38, 44 include welded aluminum couplings (not shown) at each end to provide closed fluid connection means between the aluminum blocks 42, 38, 44 and the polymer tubing 72 making up a portion cool fluid conduit 26. The radiator 28 of this exemplary embodiment is manufactured from aluminum and provides a plurality of fluid conduits for the cool fluid flow in such a manner so as to attempt to maximize the surface area of the radiator 28 in concurrent contact with the air 60 and the cool fluid for efficient thermal energy transfer. The thermal energy sink 30 of this exemplary embodiment is manufactured from copper and may be configured in whatever geometric arrangement as circumstances dictate, but for explanation purposes only, the thermal energy sink 30 in the closed system is a section of copper tubing 68 run in a serpentine pattern.

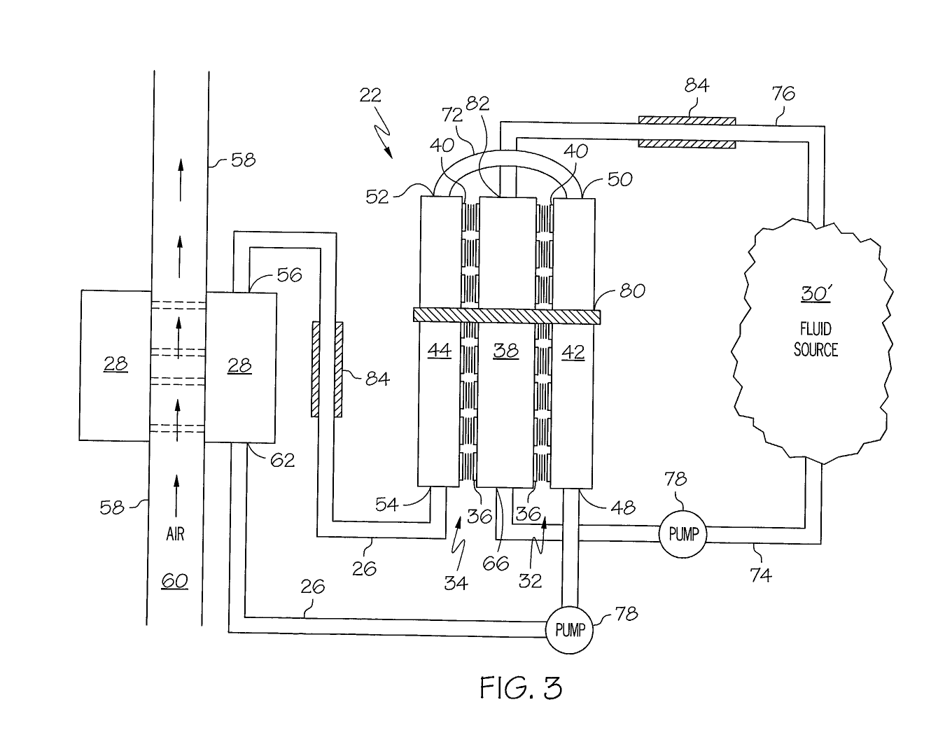

FIG. 3 illustrates an alternate thermal energy sink 30′ having an open system comprising two sections of tubing 72 providing and inlet 74 and an outlet 76 for fluid flow. Two centrifugal pumps 78 are utilized in the above-described exemplary embodiments to distribute the cool fluid and the warm fluid throughout the system; however, positive displacement or other dynamic pumps may be utilized.

Assembly of the heat-exchanging core 22 of the above-described exemplary embodiments may begin by positioning the first and second banks 32, 34 into thermal communication with the second block 38. A thermal grease (not shown) may be applied to both the warming surfaces 36 and the cooling surfaces 40 of the first and second banks 32, 34 before being mounted onto a block. After the warming surfaces 36 of the first and second banks 32, 34 have been positioned on opposing sides of the second block 38, the first and third blocks 42, 44 are positioned so as to be in thermal communication with the cooling surfaces 40 of the first and second banks 32, 34 respectively. A bracket 80 maintains the position of the first, second and third blocks 42, 38, 44 in relation to one another and also maintains the positioning of the first and second banks 32, 34. However, a thermal epoxy or other mounting means may be utilized in place of, or in conjunction with, the brackets 80. The outlet 50 of the first block 42 and inlet 52 of the third block 44 are in fluid communication with one other via the polymer tubing 72 mounted to the coupling means (not shown) of each block. The heat-exchanging core 22 at this point is ready for attachment to four fluid conduits; the warm fluid inlet to the second block 38, the warm fluid outlet from the second block 38, the cool fluid inlet to the first block 42, and the cool fluid outlet from the third block 44. At least two preexisting conduits may be run from the radiator 28 to provide fluid communication with the entrance 48 of the first block 42 and outlet 54 of the third block 44, while at least two preexisting conduits may be run from the thermal energy sink 30 to provide fluid communication with the entrance 66 of the second block 38 and outlet 82 of the second block 38.

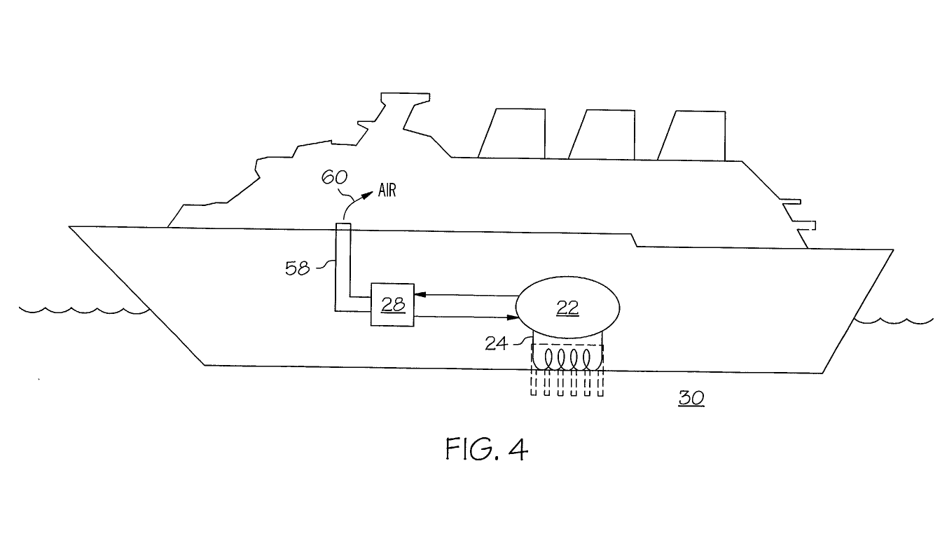

Referencing FIG. 4, an application of the embodiments of the present invention may be a cooling system for a boat or within a structure in proximity to a fluid body 30. In this exemplary application, air 60 within the cabin or enclosed area of the boat or structure is cycled into thermal communication with a radiator 28 to thereby cool the air 60. The thermal energy is absorbed by the cool fluid from the air 60 is thereafter transferred to the warm fluid via the heat-exchanging core 22. The cooled air 60 is directed through the ductwork 58 and directed to various locations throughout the boat or structure, while the cool fluid is cycled back to the heat-exchanging core 22. The warm fluid conduit 24 providing water to the heat-exchanging core 22 is in thermal communication with a thermal energy sink 30, which is, in this exemplary application, a fluid body 30 such as a lake, river or ocean in contact with a finned heat transfer material. The water of the fluid body 30 provides an avenue through which thermal energy transfer may be facilitated with the warm fluid. As the warm fluid is pumped through the finned heat transfer material, thermal energy travels through the heat transfer material and thereafter dissipated to the water body 30. It is to be appreciated by one of ordinary skill, that a transition from conductive heat transfer to convective heat transfer is created by higher and higher velocity and direction differentials of the water and the thermal energy sink in relation to one another.

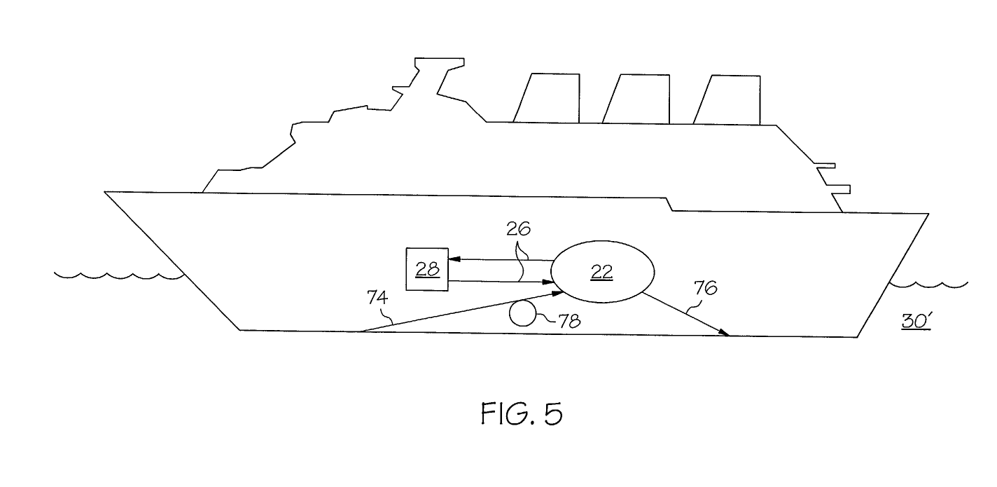

Examining FIG. 5, the alternate exemplary embodiment shown in FIG. 3 may also find an application on board a boat or within a structure in proximity to a fluid reservoir. In this exemplary application, air 60 within the cabin or enclosed area of the boat is cycled into thermal communication a radiator 28 to thereby cool the air 60. The air 60 is reduced in thermal energy as it comes into thermal communication with the cool fluid only to thereafter continue through the ductwork 58 to desired locations throughout the boat. The cool fluid increased in thermal energy cycled back to the heat-exchanging core 22 and brought into thermal communication with the warm fluid. The warm fluid in this exemplary application is water drawn from the thermal energy sink 30′ that happens to be a body of water. The warm fluid conduit carrying the warm fluid includes an entrance conduit 74 for feeding water (warm fluid) from the thermal energy sink 30′ to the heat-exchanging core 22, and an exit conduit 76. As the water exits the heat-exchanging core 22, it is carried by the exit conduit 76 to an exit point, where it is discharged back to the fluid body 30′. Taking advantage of the forward velocity of the boat, it may be advantageous to have the entrance conduit 74 facing the bow. In so doing, as the boat moves through the water, water is pushed into the entrance conduit 74, through the heat-exchanging core 22, and through the exit conduit 76 approximate the stem of the boat. An auxiliary pump may be provided to supplement the water intake in cases where the velocity of the boat is not great enough to reach the desired flowrate of water through the heat-exchanging core 22. Furthermore, filters (not shown) may be installed in-line to filter the water drawn from the fluid body 30′.

While the above exemplary embodiments have been explained with reference to a single portion of fluid at two distinct points and comparing the properties exhibited at each of these points by the fluid, it is to be understood that the fluid within the heat-exchanging core 22, the fluid conduits 24, 26, the radiator 28 and the thermal energy sink 30 is in continuous flow so long as the pumps 78 of the exemplary embodiment are functioning.

Referring again to FIGS. 2 and 3, insulation 84 may be utilized to insulate the cool fluid conduit 26, the exposed portions of the first and third blocks 42, 44, as well as the exposed portions of the thermoelectric devices 10 and the radiator 28 when cooling is desired. Conversely, insulation 84 may be utilized to insulate the warm fluid conduit 24, as well as the exposed portion of the second block 38, and the exposed portions of the thermoelectric devices 10 when heating is desired. The insulation 84 may be any type of insulation that withstands the conditions of intended use and is a poor conductor of thermal energy such as, depending on the circumstances, foams (such as latex, stryofoam, polyurethane), glass wools, wood, plastics, rubbers, corks, glass, cotton and aerogels.

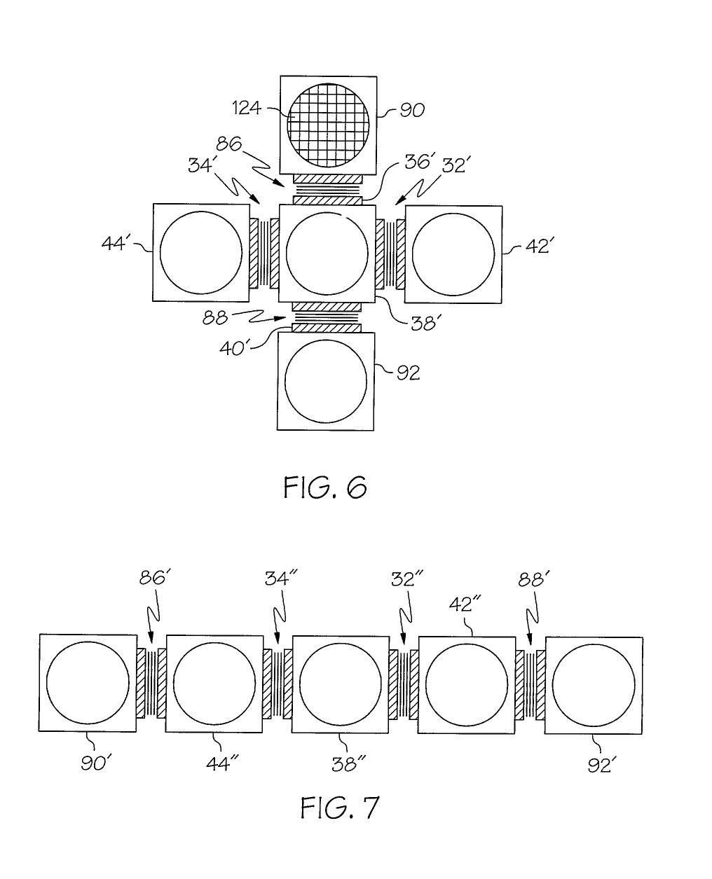

It will be apparent to one of ordinary skill that the configuration of the heat-exchanging core 22 in the first exemplary embodiment may be modified without departing from the scope and spirit of the invention. For example, as shown in FIGS. 6 and 7, the heat-exchanging core 22 of the exemplary embodiments might include a third and fourth bank of thermoelectric devices 86, 88 positioned such that the warming surfaces 36′ would be in thermal communication with the second block 38′, and the cooling surfaces 40′ would be in thermal communication with fourth and fifth blocks 90, 92 of heat transfer material, thereby providing a third and fourth pass for the cool fluid. In addition, the blocks of the heat-exchanging core 22 may be oriented, as in FIG. 7, to provide the fourth and fifth blocks 90′, 92′ stacked on top of the first and third blocks 42″, 44″ respectfully, with the third bank 86′ between the third and fourth blocks 44″, 90′, while the fourth bank 88′ is between the first and fifth blocks 42″, 92′, thereby providing three passes for the warm fluid and two passes for the cool fluid.

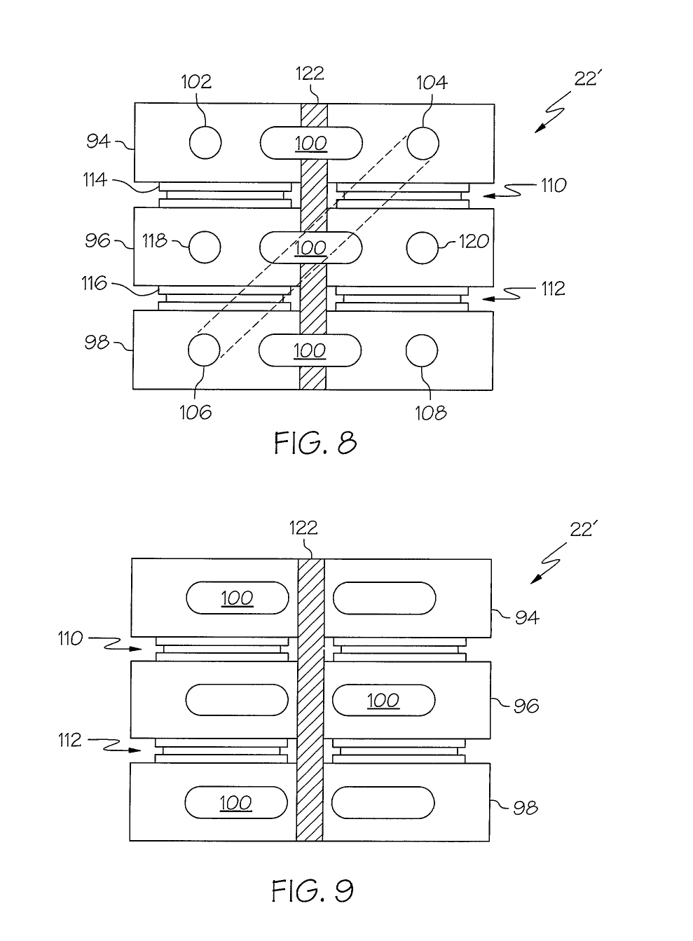

FIGS. 8 and 9 show front and rear views, respectively, of additional embodiments of the heat-exchanging core 22′. The heat-exchanging core 22′ includes three blocks 94, 96, 98 of heat transfer material, with the first 94 and third 98 blocks having internal conduits in fluid communication with one another. The first block 94 is machined or molded to receive copper tubing 100 run in a serpentine pattern. The inlet 102 to the copper tubing 100 is in fluid communication with the cool fluid conduit (not shown), while the outlet 104 of the copper tubing 100 of the first block is in fluid communication with the inlet 106 of the copper tubing 100 of the third block 98. The third block 98 is also machined or molded so as to receive a second section of copper tubing 100 in a serpentine path. The outlet 108 of the copper tubing 100 of the third block 98 feeds the cool fluid conduit (not shown). Between the first 94 and third 98 blocks are the first 110 and second 112 banks of thermoelectric devices along with the second block 96. The first 110 and second 112 banks of thermoelectric devices are in electrical communication and again oriented so as to provide thermal communication between the cooling surfaces 114 and the first 94 and third 98 blocks, while the warming surfaces 116 are in thermal communication with the second block 96. The second block 96 also has copper tubing 100 distributed throughout in a serpentine manner. The inlet 118 and outlets 120 of the second block 96 are in fluid communication with the warm fluid conduit (not shown). The first 94, second 96 and third 98 blocks may be mounted to one another using a bracket 122, or a thermally conductive epoxy may be applied to the cooler and warmer surfaces and thereafter mounted to their respective blocks.

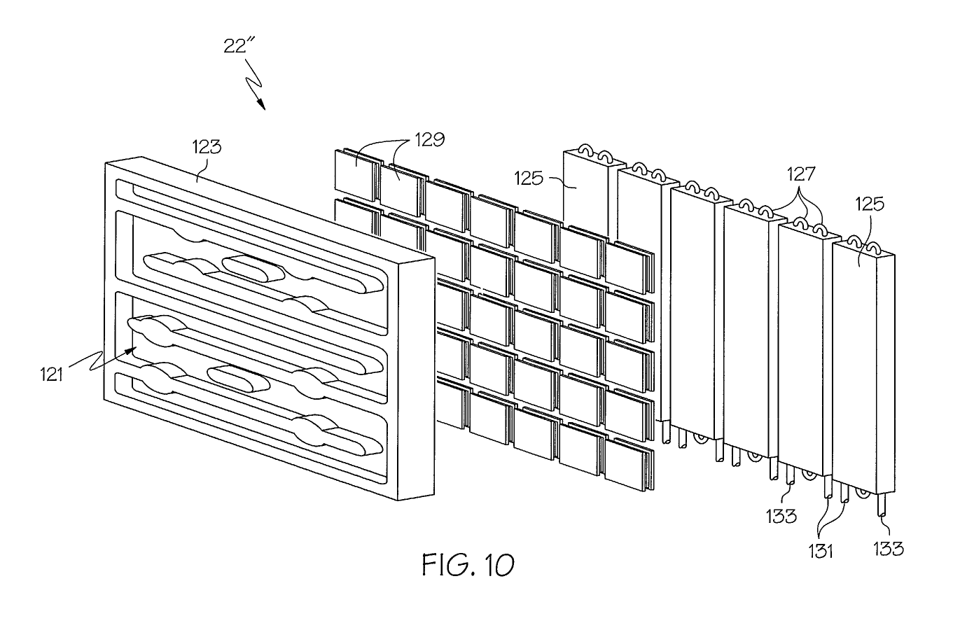

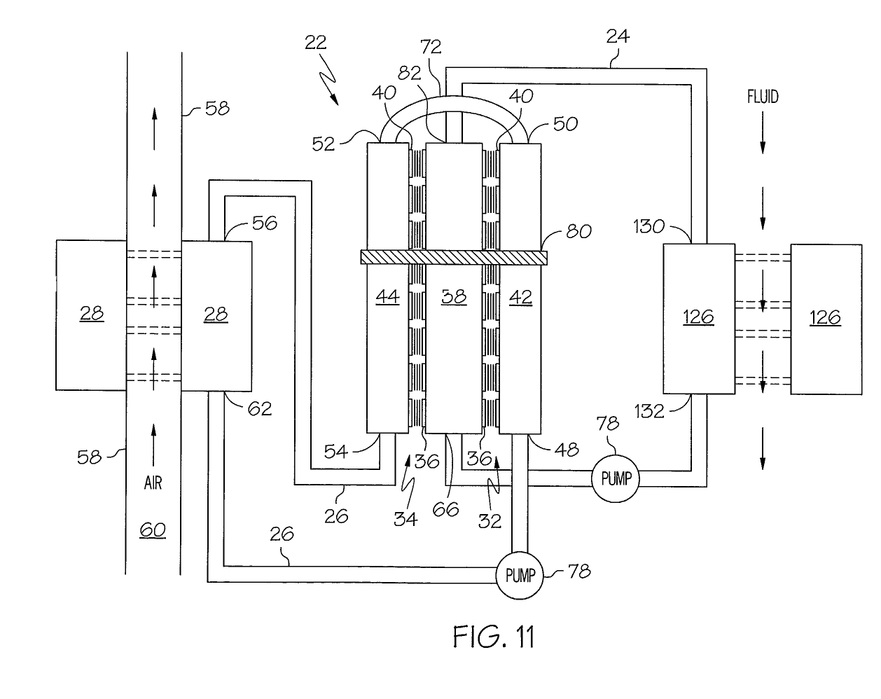

FIG. 10 shows an exploded view of another exemplary embodiment of a heat exchanging core 22″ that includes: a first block of aluminum, acting as a heat transfer material, having an upper half (not shown) and a lower half 123 manufactured to mate together and provide a single conduit 121 with a serpentine path; and a second set of blocks of aluminum 125 material having individual blocks of copper tubing 127 embedded therein. When the heat exchanging core 22″ is assembled, the first and second blocks 123, 125 of aluminum sandwich a plurality of thermoelectric devices 129 therebetween. The individual blocks of copper tubing have an outlet 131 and an inlet 133 that are each connected to a manifold (not shown) that is in fluid communication with a unitary fluid supply line (not shown) and a fluid return line (not shown).

It should be apparent to one of ordinary skill that the warm fluid and the cool fluid may be of the same formulation or of different formulations. So long as the warm fluid and the cool fluid enable effective thermal energy transfer to and/or from the fluid, the composition of the fluids is arbitrary. One of ordinary skill in the art will surly notice that the volumetric flow rate of the respective fluids may be increased or decreased to compensate for degradation of heat transfer properties exhibited by the fluids over time, or to compensate for one of the fluids having a different heat capacity as compared to the other fluid. It will also be apparent to one of ordinary skill in the art that while the previous exemplary embodiment was described utilizing two separate pumps, a single pump having two separate inputs and two separate outputs may also be used.

Also apparent to one of ordinary skill will be the ability to modify the fluid flow paths or the character of the fluid paths through the heat-exchanging core 22, 22′, 22″. The blocks of heat transfer material 42, 42′, 42″, 38, 38′, 38″, 44, 44′, 44″, 90, 90′, 92, 92′, 94, 96, 98 may contain a single conduit having a non-linear path, a plurality of conduits for fluid flow, or not even contain a fluid conduit at all by simply providing a conductive heat transfer medium between a fluid path and the warming 36, 36′, 116 or cooling surfaces 40, 114 of the thermoelectric banks 32, 32′, 32″, 34, 34′, 34″, 86, 86′, 88, 88′. The fluid paths or conduits may be equipped with turbulent flow means 124 (see FIG. 6) such as, without limitation, commercially available burl saddles or interlox saddles and thermally conductive impediments, such as wire mesh, that are positioned to maintain and/or create turbulent fluid flow. While the above embodiments have been explained with the cooler fluid flowing through the first 42, 42′, 42″, 94 and third blocks of heat transfer material 44, 44′, 44″, 98, it is also permissible to switch the conduits such that the warm fluid flows through the first 42, 42′, 42″, 94 and third blocks 44, 44′, 44″, 98, while the cool fluid passes though the second block 38, 38′, 38″, 96 and concurrently change the direction of current supplied to the first 32, 32′, 32″, 110 and second banks 34, 34′, 34″, 112 to effectively provide a dual pass for the warmer fluid.

It is also within the scope and spirit of the exemplary embodiment of the present invention to provide a radiator in place of a thermal energy sink and vice versa. It is further within the scope and spirit of the exemplary embodiment of the present invention to adapt the exemplary embodiment for various uses including, but not limited to, cooling air within a vehicle, cooling an electrical circuit or processor, cooling air delivered to a combustion chamber of an internal combustion engine and cooling a beverage dispenser. FIGS. 4-5, 12-14,17-19 22 and 25 show exemplary embodiments in which the heat-exchanging core 22 is in fluid communication with two radiators 28, 126 (convection), one radiator 28 (convection) and one thermal energy sink 30 (conduction), and two thermal energy sinks 30, 128 (conduction).

Referencing FIG. 11, another exemplary embodiment of a double loop convection/convection system is shown which may be adapted for: cooling air within the cabin area of a vehicle; concurrently heating fuel and cooling air entering the combustion chamber; cooling the air within a beverage dispenser; cooling a fluid mixture downstream or upstream in relation to a turbocharger; cooling a vehicle lubricant; or cooling the air within a structure. This exemplary embodiment includes the heat-exchanging core 22 having first and third blocks of heat transfer material 42, 44 coupled in series with a first radiator 28 via cold fluid conduit 26 and the bridge conduit 72, and a second block of heat transfer material 38 coupled in series with a second radiator 126 via warm fluid conduit 24. The process for producing cooled air 60 with respect to the first radiator 28 is generally the same as in the first exemplary embodiment and is not discussed in deference to brevity. As the warm fluid exits the second block 38 of the heat-exchanging core 22, the warm fluid travels through the warm fluid conduit 24 to the entrance 130 of the second radiator 126. An exemplary closed system as shown in FIG. 10 might utilize the pre-existing radiator of a vehicle as the second radiator 126 through which to cycle the warm fluid before the warm fluid exits 132 the second radiator 126. Thereafter, the warm fluid is pumped to the entrance 66 of the second block 38 to again pass within thermal communication of the first and second banks 32, 34.

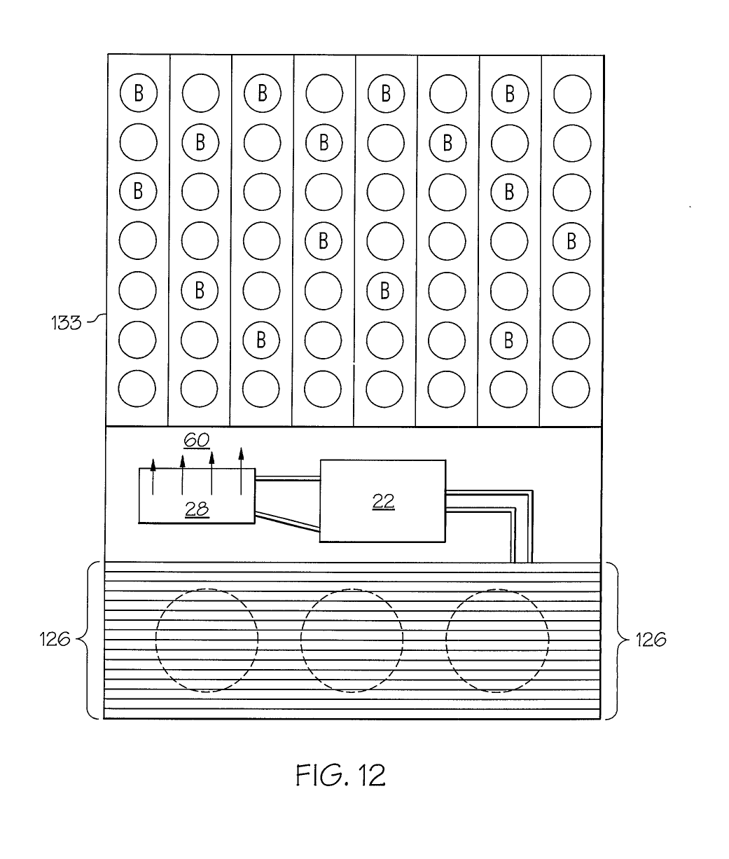

Examining FIG. 12, above-described exemplary embodiment may find application with a beverage dispenser cooler/heater. A typical beverage dispenser (with the face off) that dispenses canned or bottled beverages B, within a structure or outside a structure, having an internal radiator 28 and an external radiator 126. The canned or bottled beverages B are stacked vertically within an insulated cabinet 133 and are cooled by two fans that create convective currents past the first radiator 28 and into the cabinet 133. As the air 60 within the cabinet 133 passes over the internal radiator 28, the air 60 is cooled, and subsequently cools the beverages by convection. The cool fluid passing through the internal radiator 28 is thereby heated by the air 60 and returned to the heat-exchanging core 22 to be further cooled and thereafter cycled back to the internal radiator 28. Outside of the insulated cabinet 133, an exterior radiator 126 includes three fans that provide convective currents of ambient external air to cool the warm fluid passing within the radiator 126. After the warm fluid has been cooled, the warm fluid returns to the heat-exchanging core 22 to be brought into thermal communication with the cool fluid and increased in thermal energy. The warm and cool fluids may be of various compositions, but it is preferred that the fluids chosen do not freeze during winter months if the beverage dispenser is outside.

It is also within the scope of this exemplary application to monitor the internal temperature of the insulated cabinet 133 and electronically control the polarity or presence of the current to the first and second banks of thermoelectric devices. One distinct advantage the second exemplary embodiment has over a typical refrigeration cycle is the ability of the embodiment to heat the insulated cabinet 133, for example, to keep the beverages from freezing and exploding during the winter months. This may be accomplished by simply switching the polarity of the electric current when necessary. A conventional control system, as described below, may be used to sense the temperature of the cabinet 133 and/or the ambient environment and control the power to and polarity of the thermoelectric devices 10 accordingly. It may also be preferred to stock the beverage dispenser with beverages that consumers prefer to be dispensed warm or hot. If heating is desired, the polarity is simply switched to the first and second banks, and the internal radiator 28 now creates a heating environment that provides warm or hot beverages to the consumer, while the external radiator 126 functions so provide a thermal energy source. When the appropriate temperature within the beverage dispenser has been reached, power is no longer provided to the thermoelectric devices.

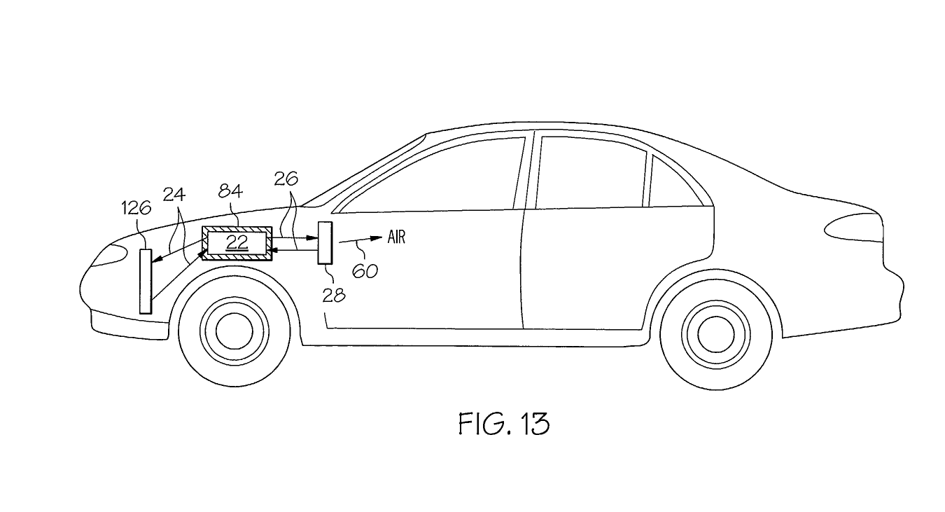

Referencing FIG. 13, the above-described exemplary embodiment may find application as an automotive air conditioner/heater. Generally speaking, the embodiment utilizes the vehicle's own pre-existing radiator 126 (or a dedicated radiator) to transfer energy away from the heat-exchanging core. The heat exchanging core 22 is insulated 84 and in thermal communication with the cool fluid via the cool fluid conduit 26 entering and exiting the heat-exchanging core 22. The cool fluid conduit 26 is insulated (not shown) for the majority of its length and feeds cool fluid to the first radiator 28. The first radiator 28 is integrated into the vehicle ventilation system such that when the occupants of the vehicle desire cooled air 60, a fan provides forced convection over the first radiator 28 so as to effectively cool the air 60 circulating within the cabin. The air 60 may be recirculated throughout the cabin or may be drawn from ambient outside air; in either case, the air fed to the first radiator 28 is reduced in thermal energy. The second radiator 126 may be the vehicle's own radiator and is connected to the heat-exchanging core 22 via the warm fluid conduit 24. Additionally, the embodiment utilizes the vehicle's own heat transfer fluid (typically a portion of which is a glycol) as the warm fluid, and may utilized any fluid as the cooling fluid so long as operating conditions are within phase-change parameters of the cool fluid.

Alternatively, the above-described exemplary embodiment may be utilized as a vehicle cabin heater. By simply switching the polarity to the first and second banks, the first radiator 28 is turned into an air heater, providing air 60 to the cabin of the vehicle at a higher temperature than either the outside air or the inside cabin air.

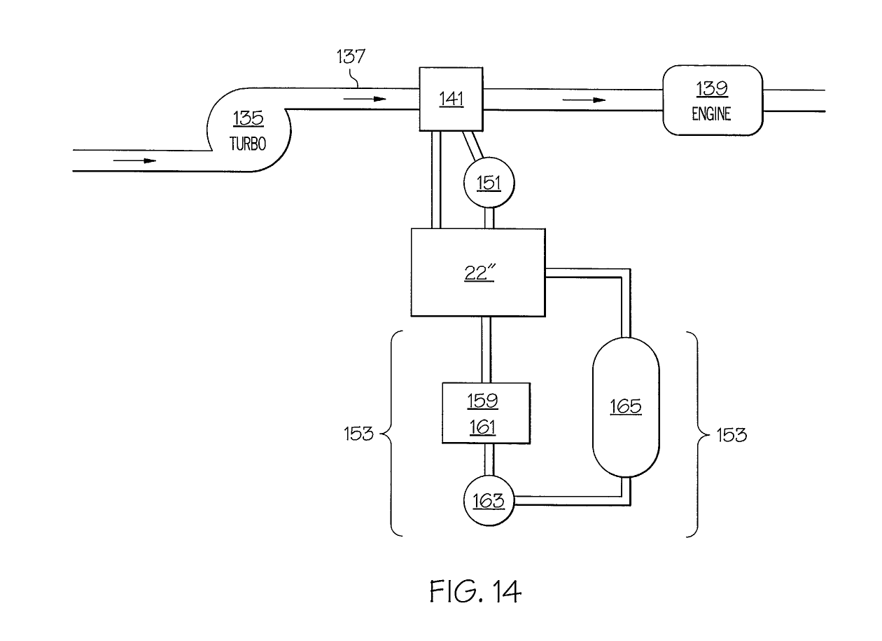

FIG. 14 shows a schematic of an above-described exemplary embodiment functioning as an air intake cooler. The schematic reflects the interaction between the heat-exchanging core 22″ and an internal combustion process and associated apparatuses. The solid lines reflect the path of the air as it proceeds through a turbocharger 135 and an air conduit 137 on its way to a combustion chamber of an engine 139. Hot exhaust gases exiting the engine 139, drive the turbocharger 135 which in turn, increases both the temperature and pressure of the air downstream from the turbocharger 135. This hot, pressurized air is conveyed through the air conduit 137 that is mounted to an in-line radiator 141, so as to cool the air within the air conduit 137 via convection.

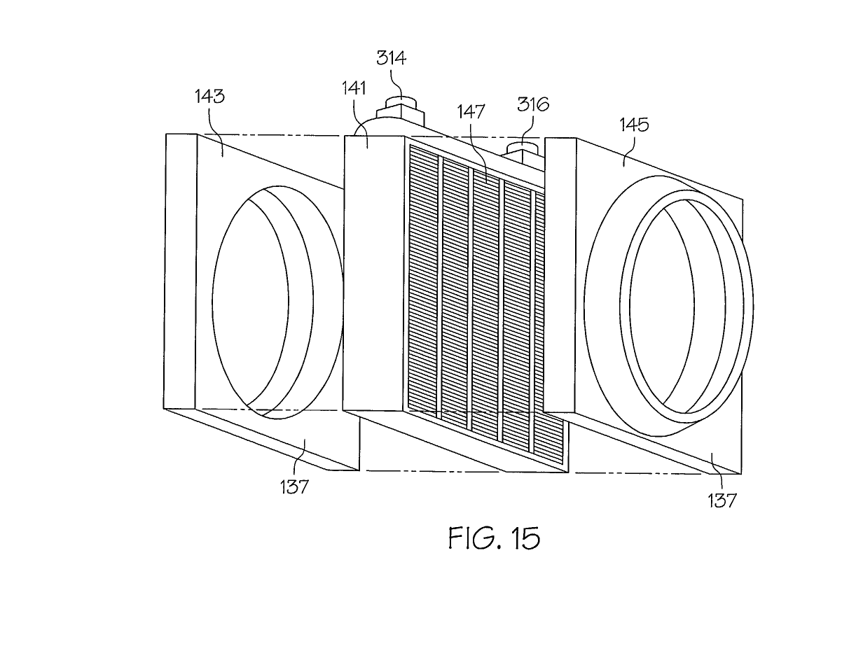

FIG. 15 shows an exemplary exploded view of a downstream interface plate 143 and the upstream interface plate 145 of the air intake conduit 137 that sandwich therebetween the in-line radiator 141, which has a plurality of cool fluid conduits 147 running therethrough. The in-line radiator 141 has an outlet 314 that is in fluid communication with the heat-exchanging core 22″, and an inlet 316 that is in fluid communication with a first pump 151. Cool fluid is cycled through the in-line radiator 141 and delivered to the heat-exchanging core 22″ so as to enable thermal communication between the cooling surfaces of the thermoelectric devices, thereby cooling the cool fluid. The thermal energy transferred to the cooling surfaces is pumped to the warming surfaces that are in thermal communication with a warm fluid. The warm fluid conduits of the heat-exchanging core 22″ are in fluid communication with a platform system 153.

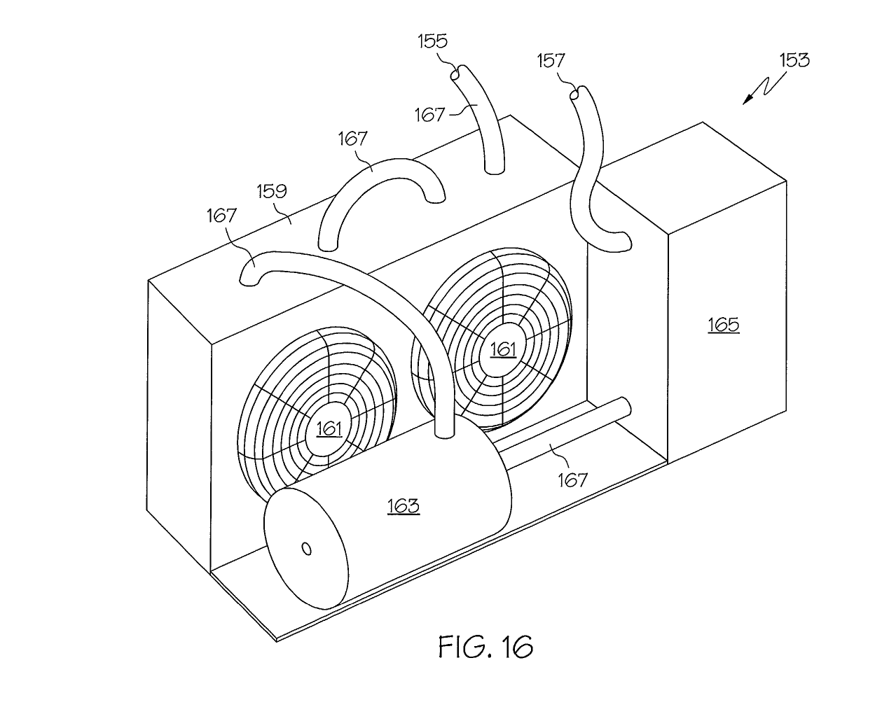

FIG. 16 shows an exemplary heat-dissipation platform system 153 that includes a fluid inlet 155 and outlet 157 that attach to the heat-exchanging core 22″, as well as an auxiliary radiator 159 with electric fans 161, a second pump 163 and a fluid reservoir 165 all connected via a warm fluid conduit 167. This auxiliary radiator 159 transfers a portion of the thermal energy of the warm fluid to the surroundings, thereby cooling the warm fluid before it enters the heat-exchanging core 22″.

It is to be understood that the radiator 141 can be replaced by any alternative heat transfer device such as a finned block of heat transfer material in thermal communication with the cooling fluid conduit 26″, and that the radiator 141 (or alternative device) can be positioned downstream or upstream from the turbocharger 135. It will also be appreciated that the invention may be used with any air stream within a vehicle to cool or heat the airstream.

It should be realized by one of ordinary skill that structural configurations of the thermoelectric heat exchanger may be arbitrary so long as thermal communication is established between the cooler fluid and the cooling surface of the thermoelectric device, as well as between the warmer fluid and the warming surface of the thermoelectric device. Variable flow rates for the cool and warm fluid are also within the scope and spirit of the present invention. While the composition of the cool or warm fluid has not been specifically disclosed, it should be understood that it is generally envisioned that a single composition will not have universal application. Thus, simple water and glycol solutions may be utilized, as well as specialized heat transfer fluids (depending upon the application and ambient conditions) such as, without limitation, Dow SYLTHERM 800, SYLTHERM XLT, SYLTHERM HF, DOWTHERM A, DOWTHERM J, DOWTHERM Q, DOWTHERM T, DOWTHERM SR-1, DOWFROST, DOWTHERM 4000, DOWFROST HD, DOWCAL N, DOWCAL 20, DOWCAL 10. Additionally, it is also within the scope and spirit of the present invention to utilize insulation to cover the piping carrying the cool fluid as well as the radiator in series with the air intake conduit and the downstream portion of the air intake conduit from the radiator.

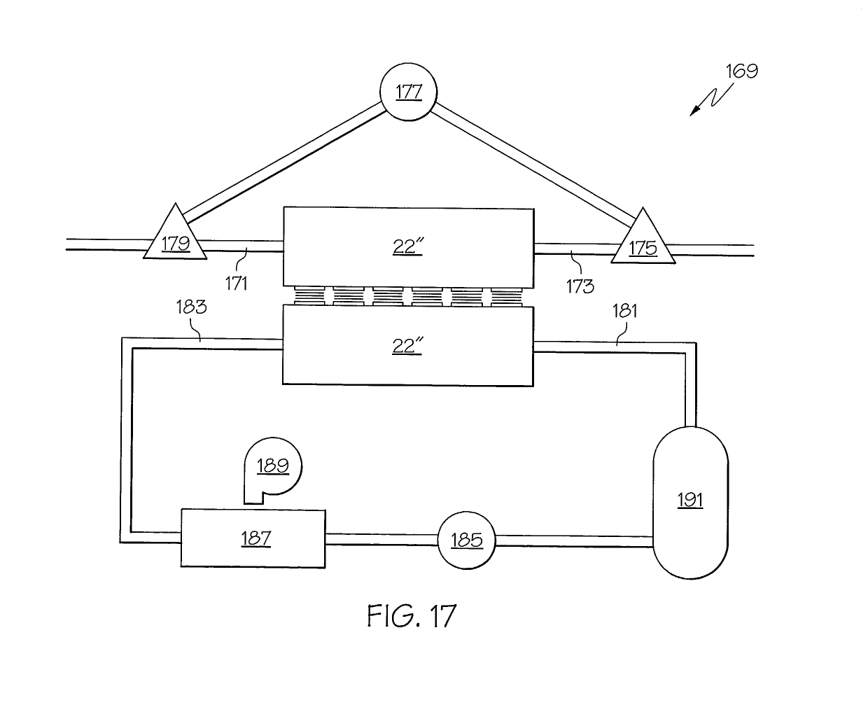

Referencing FIG. 17, the above-described exemplary embodiment may function as a water cooler and/or water heater for a beverage dispenser. The beverage dispenser 169 includes the heat-exchanging core 22″, entering 171 and exiting 173 supply lines for the water within the heat-exchanging core 22″, a control valve 175, a first pump 177, a supply valve 179, entering 181 and exiting 183 supply lines for the warm fluid within the heat exchanging core 22″, a second pump 185, a radiator 187 with convective means 189, and a warm fluid reservoir 191. As the water passes through the supply valve 179, it passes into the entering supply line 171 to the heat-exchanging core 22″, where the water is cooled to approximately 8° F. However, the water supply valve 179 closes when the pressure exerted on the exiting side approximates that on the supply side. When the supply valve and the control valve are both closed, the water is circulated through the heat-exchanging core 22″ by the first pump 177 that inhibits the formation of ice. On the other side of the heat-exchanging core 22″, a warm fluid is cycled between the auxiliary radiator 187, the warm fluid reservoir 191 and the heat-exchanging core 22″. As the warm fluid comes into thermal communication with the heat-exchanging core 22″, thermal energy is transferred to the warm fluid and subsequently dissipated while flowing through the auxiliary radiator 187 having convective means 189 such as an electric, pneumatic or hydraulic fan. After the warm fluid is decreased in thermal energy and exits the radiator 187, the warm fluid enters the warm fluid reservoir 191 until it exits the warm fluid reservoir 191 to cycle through heat-exchanging core 22″.

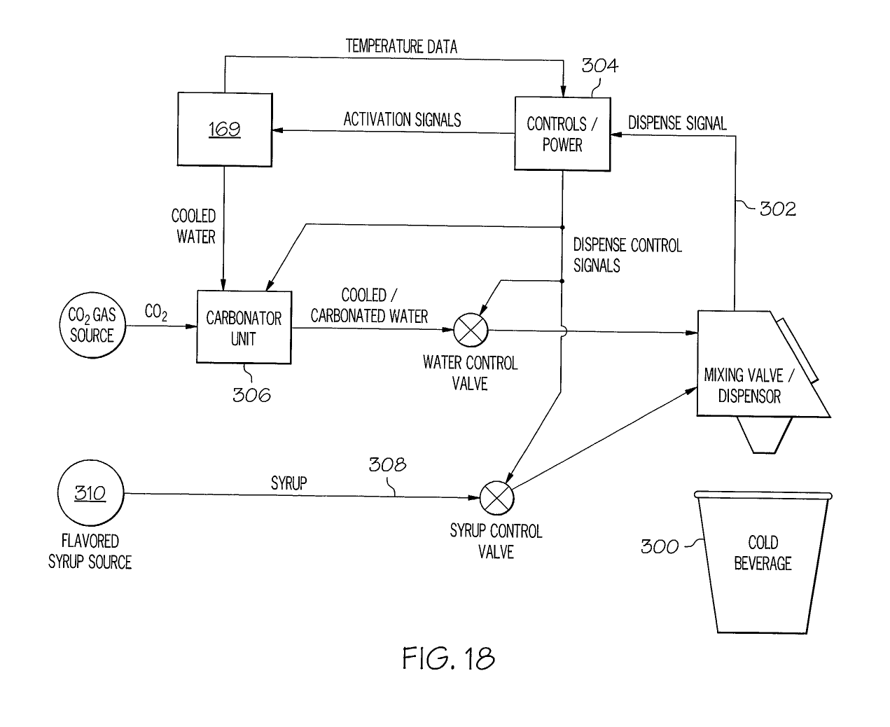

FIG. 18, shows how the exemplary beverage system 169 may be adapted to a prior art carbonated beverage dispenser so as to provide cooled water in place of the prior art water source and prior art cooling techniques. Whenever a user desires a cooled beverage 300, a dispense signal 302 is sent to the controller 304 which activates the control valve 175 to dispense cooled water to the carbonator 306 which is thereafter dispensed concurrently with a predetermined amount of syrup 308 from a flavored syrup source 310. The exemplary beverage system 169 may also be retrofitted to beverage dispensers that provide non-carbonated water for making lemonade, tea or other beverages. One of ordinary skill in the art will appreciate the capability of the exemplary beverage system 169 to concurrently provide a user with hot and cold water. Replacing the radiator with a supply valve and including a control valve, the heat-exchanging core 22″ can concurrently cool and heat water so as to provide a user of a beverage dispenser with the choice of hot or cold water.

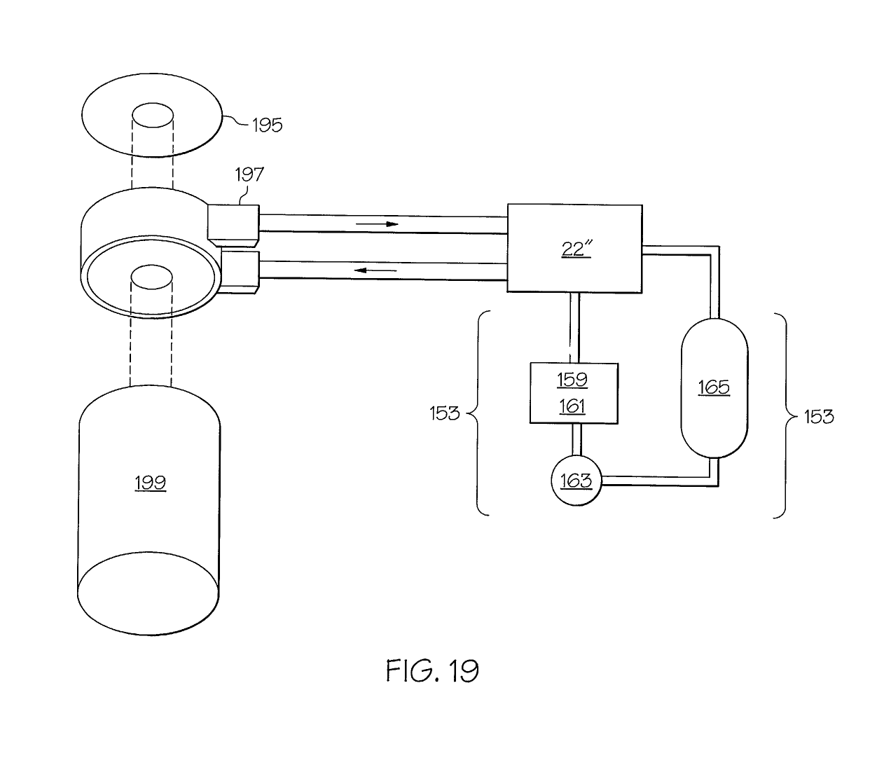

Referencing FIG. 19, a schematic is shown of an exemplary embodiment utilizing the convection/convection system of the present invention adapted to perform as an in-line lubricant cooler, and specifically an engine oil cooler for a diesel engine. A lubricant outlet 195 from an internal combustion engine is in series with a diverter 197 (similar to the diverter that is commercially available from Perma Industries, Inc. as a #189 SANDWICH ADAPTOR UNIVERSAL and adapted to work as disclosed) which delivers the lubricant to heat-exchanging core 22″ so as to enable thermal communication between the cooling surfaces of the thermoelectric devices, thereby cooling the lubricant and returning the lubricant to the lubrication system for filtration via a conventional oil filter 199. The thermal energy transferred to the cooling surfaces is pumped to the warming surfaces that are in thermal communication with a warm fluid. The warm fluid conduits of the heat-exchanging core 22″ are in fluid communication with a heat-dissipation platform system 153.

FIG. 16 shows an exemplary heat-dissipation platform system 153 that includes a fluid inlet 155 and outlet 157 that attach to the heat-exchanging core 22″, as well as an auxiliary radiator 159 with electric fans 161, a second pump 163 and a fluid reservoir 165 all connected via a warm fluid conduit 167. This auxiliary radiator 159 transfers a portion of the thermal energy of the warm fluid to the surroundings, thereby cooling the warm fluid before it enters the heat-exchanging core 22″.

It should be appreciated by one of ordinary skill that while the exemplary in-line oil cooler is shown generally utilizing an oil filter extension as the diverter 197 and the oil filter or oil filter extension interface of an internal combustion engine as the lubricant outlet 195, the exemplary oil cooler has particular application in dry sump lubrication systems. This may be accomplished by providing the heat exchanging core in series with the sump pump, thereby cooling the lubricant in-line before the lubricant is filtered and/or delivered to the lubricant storage tank.

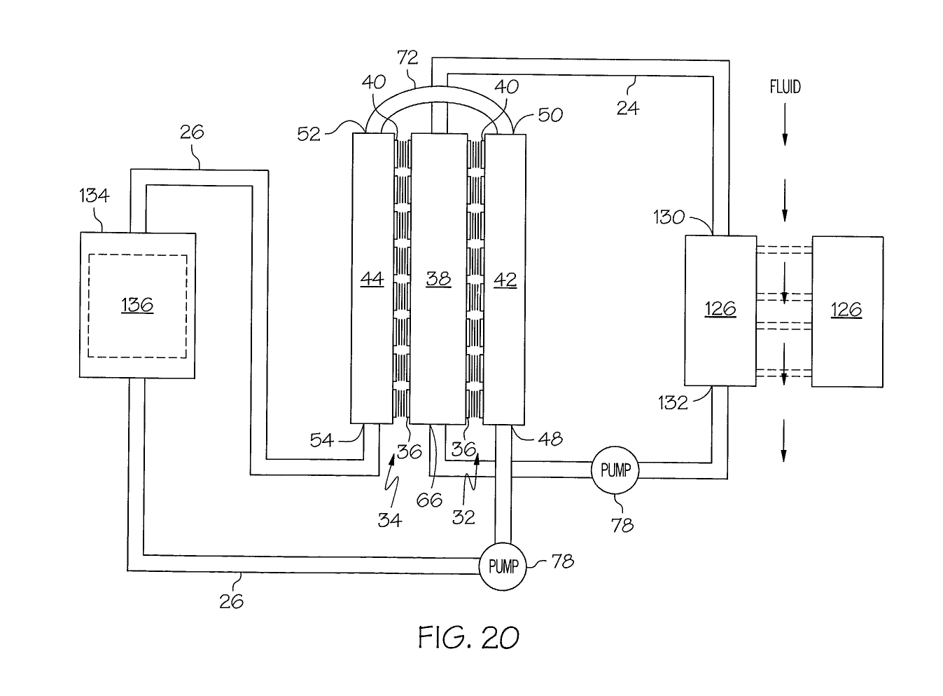

Consulting FIG. 20, an exemplary embodiment of a double loop conduction/convection system is shown for making ice or cooling a computer chip as the principles and the apparatus are very similar for each. This exemplary embodiment is shown including the same heat-exchanging core 22 having a first and third blocks of heat transfer material 42, 44, a thermal energy sink 134, a cool fluid conduit 26 extending through the first and third blocks 42, 44 and through the thermal energy sink 134, a second block 38, a radiator 126 and a warm fluid conduit 24 extending through the second block 38 and through the radiator 126. Discussion of the third exemplary embodiment is limited, for purposes of diminishing redundancy, to the thermal energy sink 134 and its interaction with a potential target 136 to be cooled. The cool fluid exiting 54 the third block 44 of the heat-exchanging core 22 is pumped through the cool fluid conduit 26 and through the aluminum conduits (not shown) of the thermal energy sink 134 that is in thermal communication with say for example, a computer chip 136. As the cool fluid flows through the aluminum conduits of the thermal energy sink 134, thermal energy is transferred from the target 136 to the cool fluid. Thereafter, the cool fluid that exits the thermal energy sink 134 is increased in thermal energy, while the target is decreased in thermal energy and thereby cooled. After the cool fluid has completed flowing through the thermal energy sink 134, it is directed back to the entrance 48 of the first block 42 of the heat-exchanging core 22.

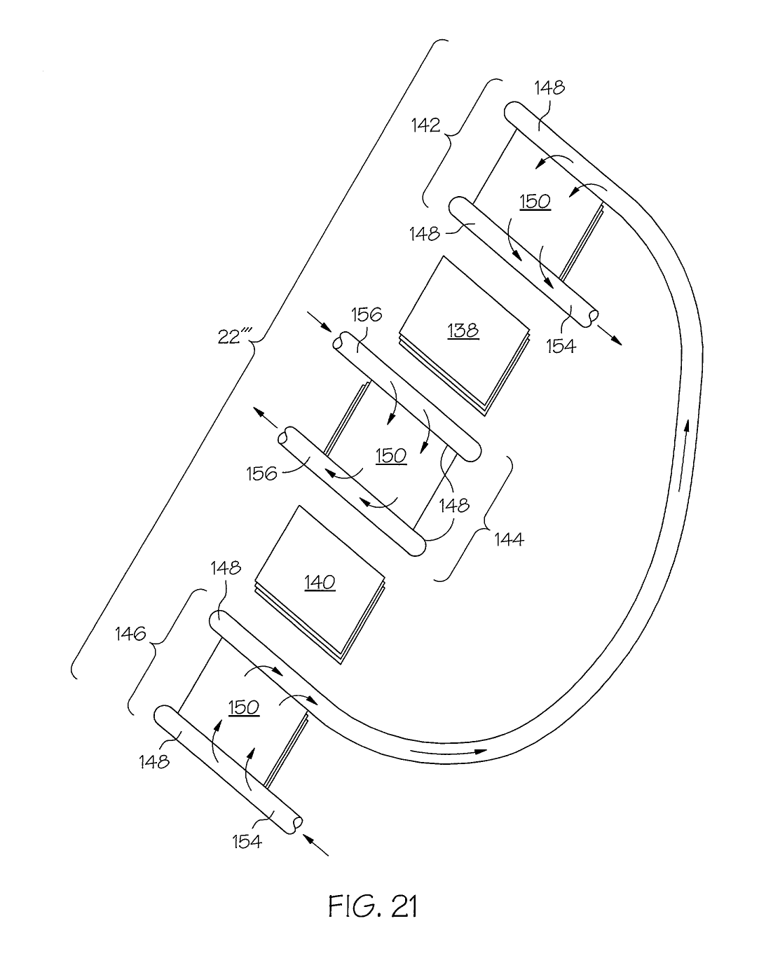

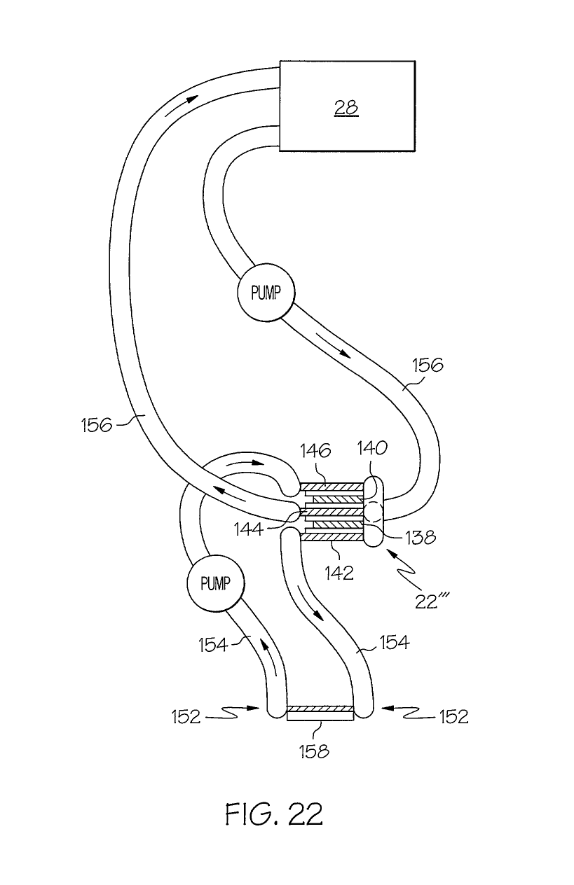

Referencing FIGS. 21 and 22, the above-described exemplary embodiment may find application as a semiconductor device (i.e. microprocessor or CPU) cooler. In this application, the heat-exchanging core 22 may be modified such that the first 138 and second 140 banks of thermoelectric devices comprise a single thermoelectric device sandwiched by three heat exchangers 142, 144, 146. The exploded view of FIG. 14 shows the two thermoelectric devices being positioned between three blocks 142, 144, 146. Each heat exchanger comprises two aluminum inlet/outlet cylinders 148 closed at one end and having a vertical opening at the other end, welded to opposite open ends of an aluminum heat transfer section 150 having two planar surfaces. In between the planar surfaces of the heat transfer section 150 are a plurality of parallel conduits for fluid flow that provide fluid communication between the opposing inlet/outlet cylinders 148. The aluminum heat transfer sections 150 of the first 142 and third 146 heat exchangers are in thermal communication with the cooler surfaces of the first 138 and second 140 bank and are coupled to a fourth heat exchanger 152 via the cool fluid conduit 154, while the aluminum heat transfer sections of the second heat exchanger 144 is in thermal communication with the warming surfaces of the first 138 and second 140 bank and are coupled to the radiator 28 via the warmer fluid conduit 156. A thermally conductive epoxy resin is applied to the aluminum cylinders to mount a thermoelectric device between the planar aspects of adjacent heat exchangers. As shown in FIG. 15, once the heat exchangers 142, 144, 146 are mounted to one another, a heat-exchanging core 22′″ is formed providing a dual pass of a nonconductive thermal energy transfer fluid with the cooling surfaces and a single pass with a second nonconductive thermal energy transfer fluid with the warming surfaces. As the semiconductor operates and produces thermal energy, the fourth heat exchanger 152 is in a conductive heat transfer relationship with the semiconductor device 158 mounted to a circuit board not shown, so as to enable the thermal energy produced by the semiconductor device 158 to gravitate from the semiconductor device 158 to the cool fluid, where it is ultimately transferred to the warmer fluid within the heat-exchanging core 22′″.

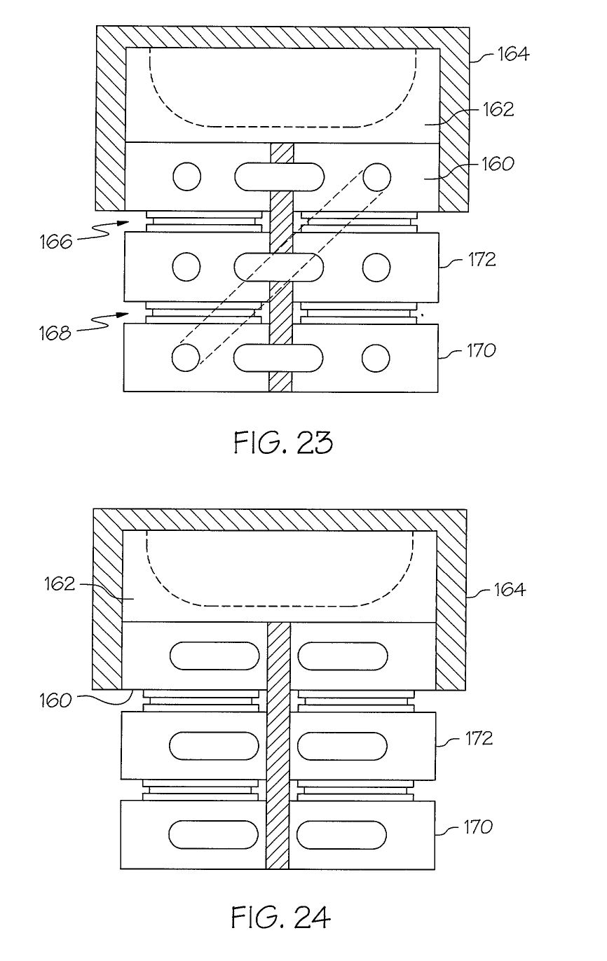

Consulting FIGS. 23 and 24 respectfully show a front and rear view of a portion of an exemplary embodiment of the present invention finding application as an icemaker. A first block of heat transfer material 160 is mounted to an upper structure 162 having a concave shape so as to facilitate the holding of a liquid. In this exemplary application, the liquid is water that is poured into the upper structure 162 and thereafter covered by insulation 164. As the first 166 and second 168 banks of thermoelectric devices are activated and the cool and warm fluid is pumped through their respective heat transfer material blocks 160, 170, 172 and associated conduits, the cooling surfaces of the first 166 and second 168 banks have the effect of withdrawing thermal energy from the cool fluid, which in turn has the effect of pulling thermal energy from the liquid water, thereby cooling the water. To the extent that a portion of the water attains a temperature low enough, the water crystallizes. When the appropriate conditions are met, the transition from liquid to solid is complete. To facilitate constant thermal energy withdrawal from the water, the cool fluid is cycled between the first 160 and third 170 blocks.

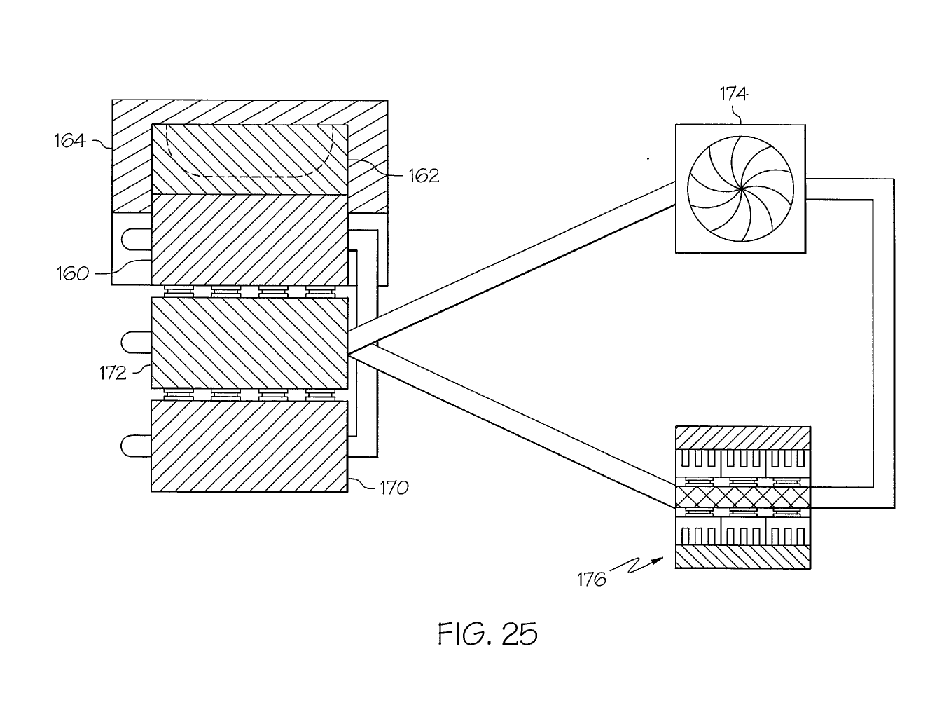

As shown in the schematic of FIG. 25, the warm liquid is cycled through the second block 172, through a radiator 174, and finally through an additional thermoelectric cooler 176 before returning to the second block 172. The thermoelectric cooler 176 utilizes thermoelectric devices having cooling surfaces in thermal communication with the warmer fluid, while the warmer surfaces are in thermal communication with heat sinks having fans mounted thereto to create convective currents over the heat sink to increase thermal dissipation from the heat sinks.

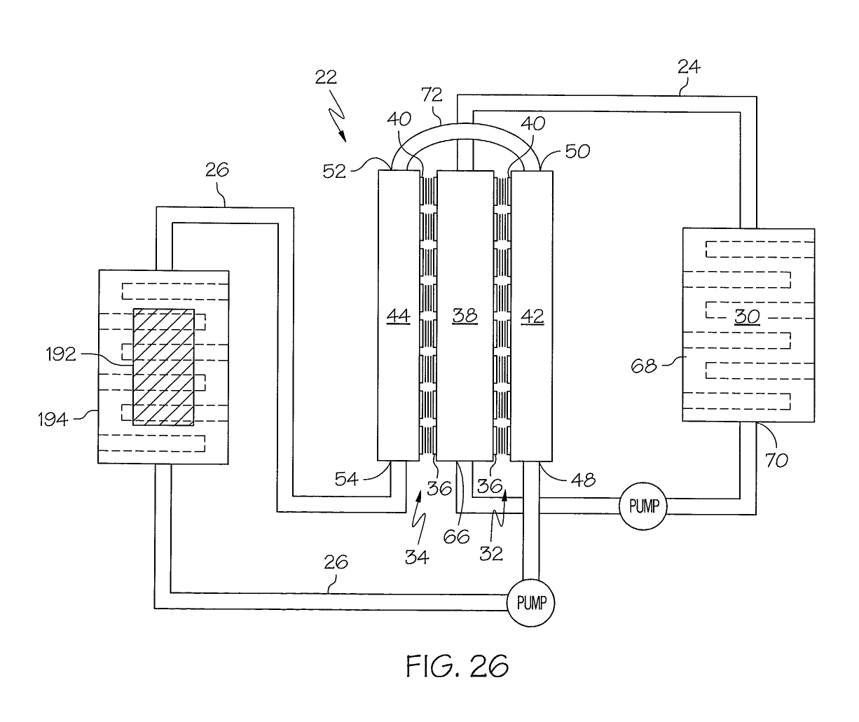

Examining FIG. 26, another exemplary embodiment of a double loop conduction/conduction system is shown for cooling a solid or gelatinous material 192 via conduction. This exemplary embodiment includes the heat-exchanging core 22 having the first and third heat transfer material blocks 42, 44 coupled in series with a first thermal energy sink 30 via cool fluid conduit 26 and bridge conduit 72, and having a second heat transfer material block 38 coupled in series with a second thermal energy sink 194 via warm fluid conduit 24. To help alleviate redundancy, reference is had to the aforementioned exemplary embodiments having a thermal energy sink coupled to the second heat transfer block or a thermal energy sink coupled to the first and third blocks, as the interaction between each is analogous to produce the present exemplary embodiment.

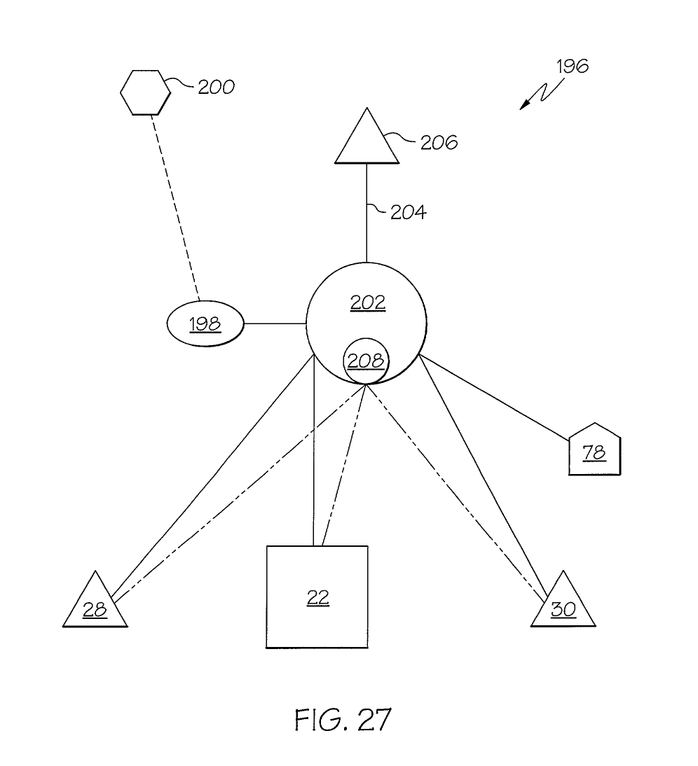

As shown in FIG. 27, a programmable remote controlled electronic control system 196 may be provided in conjunction with any of the aforementioned exemplary embodiments. The dashed lines refer to a remote control signal pathway, while the solid lines refer to a solid electrical connection and the intermittent long and short dashed lines refer to temperature data pathways. The type of control system 196 as described below is well known within the art of electronic controls and explanation shall be limited to the general aspects for purposes of brevity. The control system 196 comprises a transponder 198, a remote signal generator 200, programmable circuitry 202 and at least one power connection 204 available to receive power from a power source 206. The programmable circuitry 202 provides a user with various options, among which include delayed operation of the exemplary embodiment until a predetermined time. A built-in thermostat 208 monitors the temperature parameters for operation that may be set by a user with attached thermocouples (not shown) provide data input indicating temperature at preset locations such as the fluid input or output temperature of the radiator 26, the input or output fluid temperature of the thermal energy sink 30 and/or a point within the heat-exchanging core 22, 22′, 22″, 22′″. The control system 196 also is equipped with a remote control feature. The remote signal generator 200 feature allows a user to activate the control system 196 from a remote source, thereby activating an exemplary embodiment if conditions necessitate such operation.

As a brief example, a user desires to utilize one of the exemplary embodiments to provide cool air to the cabin of an automobile before the user enters the cabin on a hot day. The exemplary control system 196 may be powered by the automobile's battery 206 or may have its own auxiliary power system 206. In this example, the user may simply use the remote signal generator 200 to interface the control system 196 and turn on the cooling feature of an exemplary cooling/heating embodiment. The user may have already programmed in a target temperature for the cabin, say for example, 74° F. Thereafter, the control system 196 enables power to be provided to the exemplary embodiment (pumps 78, radiator 28, thermal energy sink 30 and heat-exchanging core 22, for example) and cooled air is thereafter delivered to the cabin of the vehicle until the temperature within the cabin reaches 74° F., at which point the control system 196 shuts off power to the exemplary embodiment, but continues to monitor the temperature within the automobile so as to activate the exemplary embodiment if the temperature within the automobile reaches 75° F. or above. This temperature regulation process may also be programmed to activate at a particular time(s) of the day. For example, if the user gets off work everyday at 5:00 pm, the user may program the temperature regulation control to activate at 4:30 pm so the cabin of the automobile will be comfortable by 5:00 pm. Alternatively, the control system 196 may provide warm air to the cabin of the automobile if desired by a user by switching the electric current to the first and second banks 32, 34, thereby making the first and third blocks 42, 44 the heating blocks. In this manner, the control system 196 provides a programmable lower and upper temperature range within which to maintain the temperature of the cabin of the automobile.

While the aforementioned embodiments have been explained with somewhat specific objectives (making ice, cooling a semiconductor chip, etc), other embodiments and modifications are intended to be covered by the spirit and scope of applicant's disclosure. It will be apparent to those of ordinary skill in the art that the above mentioned exemplary embodiments may be configured in a plurality of different ways to bring about the heating and/or cooling of target solids, gelatinous materials and fluids. The geometries of the conduits, the CWTDs, the radiators and the thermal energy sinks are not of a unitary nature. Those of ordinary skill will appreciate that other geometries than those discussed above may be utilized in specific applications to reduce size, increase overall efficiency and/or reduce costs. Those of ordinary skill will also appreciate that each of the exemplary embodiments may be configured to heat a solid, gelatinous material or fluid by manipulating the conduits connected to the heat-exchanging core 22, or by inverting the direction of the electron flow to the first and second banks 32, 34 such that wafers 12 heat and wafers 14 cool. Also discernable to one of ordinary skill is the flexibility of the first bank 32 or second bank 34 to be made up of a single thermoelectric device 10.

While the aforementioned exemplary embodiments have been described using a first and third blocks in thermal communication with the first and second banks of thermoelectric devices, it is also within the purview of this invention to refer to segments or portions of a single body of heat transfer material as being the first block and third block. In such an application, the reference to two or more blocks is directed at describing the location of elevated thermal transfer through the heat transfer material and between a target and the surface of the thermoelectric device. In an exemplary application, a single piece of heat transfer material has an orientation (potentially U-shaped) to allow concurrent thermal communication between the heat transfer material and the first and second banks of the thermoelectric devices.

As a caveat to the heat transfer materials discussed above, it will be well understood by those skilled in the art that aluminum has a relatively high thermal conductivity (117 Btu/h ft ° F. at 32° F.)) as compared to other metals such as mild steel (26 Btu/h ft ° F. at 32° F.) and cast iron (30 Btu/h ft ° F. at 68° F.). While aluminum's higher thermal conductivity makes it more advantageous to use as a material through which heat or thermal energy will travel, other materials could certainly be used such as cast iron, copper (224 Btu/h ft ° F. at 32° F.), or more expensive materials such gold (169 Btu/h ft ° F. at 68° F.) and silver (242 Btu/h ft ° F. at 32° F.). For the purposes of this invention, therefore, a heat transfer material includes any material (metallic or non-metallic) having a suitable thermal conductivity for allowing heat transfer a warmer and cooler environment.

Following from the above description and invention summaries, it should be apparent to those of ordinary skill in the art that, while the methods and apparatuses herein described constitute exemplary embodiments of the present invention, it is to be understood that the inventions contained herein are not limited to these precise embodiments and that changes may be made to them without departing from the scope of the inventions as defined by the claims. Additionally, it is to be understood that the invention is defined by the claims and it not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A double pass heat exchanger comprising:
a first bank of thermoelectric devices that includes at least one thermoelectric device, the thermoelectric devices having cooling surfaces capable of absorbing thermal energy and opposed heating surfaces capable of dissipating thermal energy;
a second bank of thermoelectric devices that includes at least one thermoelectric device, the thermoelectric devices having cooling surfaces capable of absorbing thermal energy and opposed heating surfaces capable of dissipating thermal energy;
a first block of heat transfer material in concurrent thermal communication with a first fluid conduit and the heating surfaces of the first bank of thermoelectric devices and the heating surfaces of the second bank of thermoelectric devices; and
a second block of heat transfer material in concurrent thermal communication with a second fluid conduit and the cooling surfaces of the first bank of thermoelectric devices and the second bank of thermoelectric devices.

2. The device of claim 1, wherein the second fluid conduit contains a vehicle fluid.

3. The device of claim 2, wherein the vehicle fluid is one of:
a vehicle fuel;
a vehicle lubricant; and
a vehicle intake component.

4. The device of claim 1, wherein:
the first block includes a warm fluid inlet and a warm fluid outlet, and at least partially includes the first fluid conduit therein; and
the second block includes a cool fluid inlet and a cool fluid outlet, and at least partially includes the second fluid conduit therein.

5. The device of claim 4, additionally comprising a programmable controller being in electrical communication with at least one of the first bank and the second bank.

6. The device of claim 4, further comprising:
a first pump for pumping a warm fluid through the first fluid conduit; and
a second pump for pumping a cool fluid through the second fluid conduit.

7. The device of claim 6, wherein:
the warm fluid inlet of the first block is coupled to a warm fluid outlet of a first convective heat transfer device via the first fluid conduit;
the warm fluid outlet of the first block is coupled to a warm fluid inlet of the first convective heat transfer device via the first fluid conduit;
the cool fluid outlet of the second block is coupled to a cool fluid inlet of a second convective heat transfer device via the second fluid conduit; and
the cool fluid inlet of the second block is coupled to a cool fluid outlet of the second convective heat transfer device via the second fluid conduit.

8. The device of claim 7, wherein:
the first convective heat transfer device is a first radiator; and
the second convective heat transfer device is a second radiator.

9. The device of claim 8, wherein the second fluid conduit contains a vehicle fluid.

10. The device of claim 9, wherein the vehicle fluid is one of:
a vehicle fuel;
a vehicle lubricant; and
a vehicle intake component.

11. The device of claim 8, wherein the first fluid conduit contains a vehicle fuel.

12. The device of claim 5, wherein:
the warm fluid inlet of the first block is coupled to a warm fluid outlet of a convective heat transfer device via the first fluid conduit;
the warm fluid outlet of the first block is coupled to a warm fluid inlet of the convective heat transfer device via the first fluid conduit;
the cool fluid outlet of the second block is coupled to a cool fluid inlet of a conductive heat transfer device via the second fluid conduit; and
the cool fluid inlet of the second block is coupled to a cool fluid outlet of the conductive heat transfer device via the second fluid conduit.

13. The device of claim 12, wherein:
the convective heat transfer device is a radiator; and
the conductive heat transfer device is a solid thermal energy sink.

14. The device of claim 13, wherein:
the warm fluid inlet of the first block is coupled to a warm fluid outlet of a conductive heat transfer device via the first fluid conduit;
the warm fluid outlet of the first block is coupled to a warm fluid inlet of the conductive heat transfer device via the first fluid conduit;
the cool fluid outlet of the second block is coupled to a cool fluid inlet of a convective heat transfer device via the second fluid conduit; and
the cool fluid inlet of the second block is coupled to a cool fluid outlet of the convective heat transfer device via the second fluid conduit.

15. The device of claim 14, wherein:
the conductive heat transfer device is a solid thermal energy sink; and
the convective heat transfer device is a radiator.

16. The device of claim 6, wherein:
the warm fluid inlet of the first block is coupled to a warm fluid outlet of a conductive heat transfer device via the first fluid conduit;
the warm fluid outlet of the first block is coupled to a warm fluid inlet of the conductive heat transfer device via the first fluid conduit;
the cool fluid outlet of the second block is coupled to a cool fluid inlet of a convective heat transfer device via the second fluid conduit; and
the cool fluid inlet of the second block is coupled to a cool fluid outlet of the convective heat transfer device via the second fluid conduit.

17. The device of claim 16, wherein:
the first conductive heat transfer device is a first solid thermal energy sink; and
the second conductive heat transfer device is a second solid thermal energy sink.

18. A double pass heat exchanger comprising:
a first bank of thermoelectric devices that includes at least one thermoelectric device, the thermoelectric devices having cooling surfaces capable of absorbing thermal energy and opposed heating surfaces capable of dissipating thermal energy;
a second bank of thermoelectric devices that includes at least one thermoelectric device, the thermoelectric devices having cooling surfaces capable of absorbing thermal energy and opposed heating surfaces capable of dissipating thermal energy;
a first block of heat transfer material in concurrent thermal communication with a first fluid conduit and the cooling surfaces of the first bank of thermoelectric devices and the cooling surfaces of the second bank of thermoelectric devices;
a second block of heat transfer material in concurrent thermal communication with a second fluid conduit and the heating surfaces of the first bank of thermoelectric devices; and
a third block of heat transfer material in concurrent thermal communication with the second fluid conduit and the heating surfaces of the second bank of thermoelectric devices.

19. The device of claim 18, wherein the second fluid conduit contains a vehicle fluid.

20. The device of claim 19, wherein the vehicle fluid is one of:
a vehicle fuel;
a vehicle lubricant; and
a vehicle intake component.

21. The device of claim 18, wherein:
the first block includes a cool fluid inlet and a cool fluid outlet, and at least partially includes the first fluid conduit therein;
the second block includes a warm fluid inlet and a warm fluid outlet, and at least partially includes the second fluid conduit therein;
the third block includes a warm fluid inlet and a warm fluid outlet, and at least partially includes the second fluid conduit therein; and
the cool fluid outlet of the second block is in fluid communication with the cool fluid inlet of the third block.

22. The device of claim 21, additionally comprising a programmable controller being in electrical communication with at least one of the first bank and the second bank.

23. The device of claim 21, further comprising:
a first pump for pumping the cool fluid through the first fluid conduit; and
a second pump for pumping the warm fluid through the second fluid conduit.

24. The device of claim 23, wherein:
the cool fluid inlet of the first block is coupled to a cool fluid outlet of a first convective heat transfer device via the first fluid conduit;
the cool fluid outlet of the first block is coupled to a cool fluid inlet of the first convective heat transfer device via the first fluid conduit;
the warm fluid outlet of the third block is coupled to a warm fluid inlet of a second convective heat transfer device via the second fluid conduit; and
the warm fluid inlet of the second block is coupled to a warm fluid outlet of the second convective heat transfer device via the second fluid conduit.

25. The device of claim 24, wherein:
the first convective device is a first radiator; and
the second convective device is a second radiator.

26. The device of claim 25, wherein the second fluid conduit contains a vehicle fluid.

27. The device of claim 26, wherein the vehicle fluid is one of:
a vehicle fuel;
a vehicle lubricant; and
a vehicle intake component.

28. The device of claim 23, wherein:
the cool fluid inlet of the first block is coupled to a cool fluid outlet of a convective heat transfer device via the first fluid conduit;
the cool fluid outlet of the first block is coupled to a cool fluid inlet of the convective heat transfer device via the first fluid conduit;
the warm fluid outlet of the third block is coupled to a warm fluid inlet of a conductive heat transfer device via the second fluid conduit; and
the warm fluid inlet of the second block is coupled to a warm fluid outlet of the conductive heat transfer device via the second fluid conduit.

29. The device of claim 28, wherein:
the convective device is a radiator; and
the conductive device is a solid thermal energy sink.

30. The device of claim 23, wherein:
the cool fluid inlet of the first block is coupled to a cool fluid outlet of a conductive heat transfer device via the first fluid conduit;
the cool fluid outlet of the first block is coupled to a cool fluid inlet of the conductive heat transfer device via the first fluid conduit;
the warm fluid outlet of the third block is coupled to a warm fluid inlet of a convective heat transfer device via the second fluid conduit; and
the warm fluid inlet of the second block is coupled to a warm fluid outlet of the convective heat transfer device via the second fluid conduit.

31. The device of claim 30, wherein:
the conductive device is a solid thermal energy sink; and
the convective device is a radiator.

32. The device of claim 23, wherein:
the cool fluid inlet of the first block is coupled to a cool fluid outlet of a first conductive heat transfer device via the first fluid conduit;
the cool fluid outlet of the first block is coupled to a cool fluid inlet of the first conductive heat transfer device via the first fluid conduit;
the warm fluid outlet of the third block is coupled to a warm fluid inlet of a second conductive heat transfer device via the second fluid conduit; and
the warm fluid inlet of the second block is coupled to a warm fluid outlet of the second conductive heat transfer device via the second fluid conduit.

33. The device of claim 32, wherein:
the first conductive device is a first solid thermal energy sink; and
the second conductive device is a second solid thermal energy sink.

34. A method of cooling a fluid comprising the steps of:
providing a first bank of thermoelectric devices that includes at least one thermoelectric device and a second bank of thermoelectric devices that includes at least one thermoelectric device, the thermoelectric devices having cooling surfaces capable of absorbing thermal energy and opposed heating surfaces capable of dissipating thermal energy;
orienting the heating surfaces of the first bank of thermoelectric devices so as to at least partially face the heating surfaces of the second bank of thermoelectric devices;
orienting a first fluid conduit so as to be in concurrent thermal communication with the heating surfaces of the first bank of thermoelectric devices and the heating surfaces of the second bank of thermoelectric devices;
orienting a second fluid conduit so as to be in concurrent thermal communication with the cooling surfaces of the first bank of thermoelectric devices and the cooling surfaces of the second bank of thermoelectric devices;
directing a first fluid within the first fluid conduit and directing a second fluid within the second fluid conduit; and
activating the first and second banks of thermoelectric devices.

35. The method of claim 34, wherein the second fluid is one of:
a vehicle lubricant;
a vehicle fuel; and
a vehicle intake component.

36. The method of claim 34, further comprising providing a programmable controller system in electrical communication with at least one of the first bank and the second bank.

37. The method of claim 34, further comprising the steps of:
orienting a first block of heat transfer material so as to be in concurrent thermal communication with the first fluid conduit and the heating surfaces of the first and second banks of thermoelectric devices; and
orienting a second block of heat transfer material so as to be in concurrent thermal communication with the second fluid conduit and the cooling surfaces of the first bank of thermoelectric devices and the cooling surfaces of the second bank of thermoelectric devices.

38. The method of claim 35, further comprising the step of bringing a third fluid into thermal communication with the second fluid contained within the second fluid conduit.

39. The method of claim 38, wherein:
the third fluid is air to be delivered to the cabin of a vehicle;
the third fluid is passed over a radiator which comprises a portion of the second fluid conduit; and
the first fluid conduit is a closed loop and the first fluid is cooled by a heat exchanger before being cycled back into thermal communication with the heating surfaces of the first and second banks of thermoelectric devices.

40. The method of claim 38, wherein:
the third fluid is air to be delivered to an enclosed area of a structure;
the third fluid is passed over a radiator which comprises a first portion of the second fluid conduit; and
the first fluid conduit is a closed loop and the first fluid is cooled by a heat exchanger before being cycled back into thermal communication with the heating surfaces of the first and second banks of thermoelectric devices.

41. The method of claim 38, further comprising providing a programmable controller system in electrical communication with at least one of the first bank and the second bank.

42. The method of claim 38, further comprising the steps of:
orienting a first block of heat transfer material so as to be in concurrent thermal communication with the first fluid conduit and the heating surfaces of the first and second banks of thermoelectric devices;
orienting a second block of heat transfer material so as to be in concurrent thermal communication with the second fluid conduit and the cooling surfaces of the first bank of thermoelectric devices; and
orienting a third block of heat transfer material so as to be in concurrent thermal communication with the second fluid conduit and the cooling surfaces of the second bank of thermoelectric devices.

43. The method of claim 42, wherein:
the first block of heat transfer material includes a portion of the first fluid conduit;
the second block of heat transfer material includes a second portion of the second fluid conduit;
the third block of heat transfer material includes a third portion of the second fluid conduit.

44. A method of cooling a solid comprising the steps of:
providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy;
orienting a first fluid conduit so as to be in concurrent thermal communication with the heating surfaces of the first bank of thermoelectric devices and the heating surfaces of the second bank of thermoelectric devices;
orienting a second fluid conduit so as to be in concurrent thermal communication with the cooling surfaces of the first bank of thermoelectric devices and the cooling surfaces of the second bank of thermoelectric devices;
pumping a first fluid within the first fluid conduit and pumping a second fluid within the second fluid conduit;
activating the first bank of thermoelectric devices and the second bank of thermoelectric devices; and
bringing a solid into thermal communication with the first fluid contained within the first fluid conduit.

45. The method of claim 44, wherein the solid is a semiconductor chip.

46. The method of claim 44, wherein the solid is a metal having at least one of a fluid contained therein, a fluid passing therethrough and a fluid flowing thereon.

47. The method of claim 46, wherein the solid is an air intake conduit of an internal combustion engine, and wherein the fluid passing therethrough is air.

48. A method of cooling a solid comprising the steps of:
providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy;
providing a first block of heat transfer material in concurrent thermal communication with a first fluid conduit, the heating surfaces of the first bank of thermoelectric devices and the heating surfaces of the second bank of thermoelectric devices;
providing a second block of heat transfer material in concurrent thermal communication with a second fluid conduit and the cooling surfaces of the first bank of thermoelectric devices and the cooling surfaces of the second bank of thermoelectric devices;
pumping a first fluid within the first fluid conduit and pumping a second fluid within the second fluid conduit;
activating the first bank and the second bank; and
bringing a solid into thermal communication with the first fluid contained within the first fluid conduit.

49. The method of claim 48, wherein the solid is a semiconductor chip.

50. The method of claim 48, wherein the solid is a metal having at least one of a fluid contained therein, a fluid passing therethrough and a fluid flowing thereon.

51. The method of claim 50, wherein the solid is an air intake conduit of an internal combustion engine, and wherein the fluid passing therethrough is air.

52. A method of cooling a solid comprising the steps of:
providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy;
providing a first block of heat transfer material in concurrent thermal communication with a first fluid conduit, the heating surfaces of the first bank of thermoelectric devices and the heating surfaces of the second bank of thermoelectric devices;
providing a second block of heat transfer material in concurrent thermal communication with a second fluid conduit and the cooling surfaces of the first bank of thermoelectric devices;
providing a third block of heat transfer material in concurrent thermal communication with the second fluid conduit and the cooling surfaces of the second bank of thermoelectric devices;
pumping a first fluid within the first fluid conduit and pumping a second fluid within the second fluid conduit;
activating the first bank and the second bank; and
bringing a solid into thermal communication with the first fluid contained within the first fluid conduit.

53. The method of claim 52, wherein the solid is a semiconductor chip.

54. The method of claim 52, wherein the solid is a metal having at least one of a fluid contained therein, a fluid passing therethrough and a fluid flowing thereon.

55. The method of claim 54, wherein the solid is an air intake conduit of an internal combustion engine, and wherein the fluid passing therethrough is air.

56. An apparatus for transferring thermal energy in relation to a gas traveling through a gas intake conduit of an engine, the apparatus comprising:
a first radiator having a cool fluid inlet and a cool fluid outlet adapted to be mounted to an air intake conduit of an internal combustion engine;
a thermoelectric heat exchanger comprising:
at least one thermoelectric device concurrently absorbing thermal energy on a first surface and dissipating thermal energy on a second surface,
a cool fluid conduit in thermal communication with the first surface of the thermoelectric device, and
a heat sink in thermal communication with the second surface of the thermoelectric device; and
a first pump in fluid communication with at least one of the cool fluid inlet, cool fluid outlet and the cool fluid conduit.

57. The apparatus of claim 56, wherein the first radiator is mounted in series to the air intake conduit.

58. The apparatus of claim 57, wherein the heat sink is a convective heat sink comprising:
a finned block of heat transfer material; and
an electric fan for providing forced convective currents in proximity to a surface of the finned block of heat transfer material.

59. The apparatus of claim 57, wherein the heat sink is a convective heat sink comprising:
a second radiator having a warm fluid inlet and a warm fluid outlet;
a warm fluid conduit;
a second pump in fluid communication with at least one of the warm fluid inlet, warm fluid outlet and the warm fluid conduit.

60. The apparatus of claim 59, wherein the convective heat sink further comprises an electric fan to provide forced convective currents in proximity to the second radiator.

61. The apparatus of claim 60, wherein the convective heat sink additionally comprises a warm fluid reservoir.

62. The apparatus of claim 61, wherein the second radiator, the second pump, a portion of the warm fluid conduit and the fluid reservoir are mounted to a platform.

63. A method for transferring thermal energy in relation to air traveling through an air intake to an engine, the method comprising the steps of:
providing at least one thermoelectric device which is in thermal communication with an air intake conduit, the thermoelectric device having at least two surfaces, concurrently dissipating thermal energy on a warmer surface and absorbing thermal energy on a cooler surface when powered; and
providing power to at least the one thermoelectric device to establish a thermal gradient between air within the air intake conduit and the cooler surface of at least the one thermoelectric device.

64. A method for transferring thermal energy from a gas traveling within a gas conduit of a combustion system, the method comprising the steps of:
mounting a first radiator in series with a gas conduit;
supplying power to at least one thermoelectric device having at least two surfaces, concurrently dissipating thermal energy on a warmer surface and absorbing thermal energy on a cooler surface;
directing a cool fluid through the first radiator and into thermal communication with a gas flowing through the gas conduit so as to increase the thermal energy of the cool fluid and decrease the thermal energy of the gas;
directing the cool fluid into thermal communication with the cooler surface of the thermoelectric device so as to increase the thermal energy of the cooler surface and decrease the thermal energy of the cool fluid; and
transferring thermal energy from the warmer surface of the thermoelectric device.

65. The method of claim 64, wherein the step of transferring the thermal energy from the warmer surface of the thermoelectric device further comprises the steps of:
positioning a finned block of heat transfer material into thermal communication with the warming surface; and
powering an electric fan to provide convective currents in proximity to a surface of the finned block of heat transfer material.

66. The method of claim 64, wherein the step of transferring the thermal energy from the warmer surface of the thermoelectric device further comprises the steps of:
positioning a warm fluid conduit to be in thermal communication with the warmer surface;
directing a warm fluid through the warm fluid conduit; and
dissipating a portion of the thermal energy of the warm fluid by utilizing a second radiator in proximity to convective currents.

67. A method of providing a cooled fluid to a compartment area of a vehicle, the method comprising the steps of:
providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy;
orienting a first fluid conduit so as to be in concurrent thermal communication with the heating surfaces of the first bank of thermoelectric devices and the heating surfaces of the second bank of thermoelectric devices;
orienting a second fluid conduit so as to be in concurrent thermal communication with the cooling surfaces of the first bank of thermoelectric devices and the cooling surfaces of the second bank of thermoelectric devices;
providing electric current to the first and/or second bank of thermoelectric devices;
bringing a first fluid within the first fluid conduit into thermal communication with the heating surfaces of the first bank of thermoelectric devices and second bank of thermoelectric devices, and bringing a second fluid into thermal communication with the cooling surfaces of the first bank of thermoelectric devices and second bank of thermoelectric devices;
bringing a cooling fluid into thermal communication with the second fluid after the second fluid has been cooled by the first and second bank of thermoelectric devices; and
directing the cooling fluid into a compartment area of a vehicle.

68. The method of claim 67, further comprising the step of bringing the first fluid into thermal communication with a heat exchanger, and wherein:
the heat exchanger is a convective heat exchanger cooling the first fluid by directing air over a heat sink to dissipate thermal energy from the heat sink;
the vehicle is adapted for air travel; and
the cooling fluid is air.

69. The method of claim 67, further comprising the step of bringing the first fluid into thermal communication with a heat exchanger, and wherein:
the heat exchanger is a convective heat exchanger cooling the first fluid by directing water over a heat sink to dissipate thermal energy from the heat sink;
the vehicle is adapted for water travel; and
the cooling fluid is air.

70. The method of claim 67, further comprising the step of bringing the first fluid into thermal communication with a heat exchanger, and wherein:
the heat exchanger is a convective heat exchanger cooling the first fluid by directing air over a heat sink to dissipate thermal energy from the heat sink;
the vehicle is adapted for land travel; and
the cooling fluid is air.

71. The method of claim 67, further comprising the step of bringing the first fluid into thermal communication with a heat exchanger, and wherein:
the heat exchanger is a conductive heat exchanger cooling the first fluid by direct contact between water and a heat sink to dissipate thermal energy from the heat sink;
the vehicle is adapted for water travel; and
the cooling fluid is air.

72. The method of claim 67, further comprising the steps of:
withdrawing the first fluid from a fluid reservoir before bringing the first fluid into thermal communication with the heating surfaces of the first and second bank of thermoelectric devices bringing the first fluid into thermal communication with a heat exchanger;
depositing the first fluid back into the fluid reservoir after bringing the first fluid into thermal communication with the heating surfaces of the first and second bank of thermoelectric devices; and, wherein,
the heat exchanger is a convective heat exchanger cooling the first fluid by directing air over a heat sink to dissipate thermal energy from the heat sink,
the vehicle is adapted for air travel, and
the cooling fluid is air.

73. A method of providing a cooled fluid to a compartment area of a vehicle, the method comprising the steps of:
providing a first bank of thermoelectric devices that includes at least one thermoelectric device and a second bank of thermoelectric devices that includes at least one thermoelectric device, the thermoelectric devices cooling surfaces capable of absorbing thermal energy and opposed heating surfaces capable of dissipating thermal energy;
positioning a first block of heat transfer material in concurrent thermal communication with a first fluid conduit and the heating surfaces of the first bank of thermoelectric devices and the heating surfaces of the second bank of thermoelectric devices;
positioning a second block of heat transfer material in concurrent thermal communication with a second fluid conduit and the cooling surfaces of the first bank of thermoelectric devices and the second bank of thermoelectric devices;
providing electric current to the first and/or second bank of thermoelectric devices;
bringing a first fluid within the first fluid conduit into thermal communication with the heating surfaces of the first and second bank of thermoelectric devices, and bringing a second fluid into thermal communication with the cooling surfaces of the first and second bank of thermoelectric devices;
bringing a cooling fluid into thermal communication with the second fluid after the second fluid has been cooled by the first and second bank of thermoelectric devices; and
directing the cooling fluid into a compartment area of a vehicle.

74. The method of claim 73, further comprising the step of bringing the first fluid into thermal communication with a heat exchanger, and wherein:
the heat exchanger is a convective heat exchanger cooling the first fluid by directing air over a heat sink to dissipate thermal energy from the heat sink;
the vehicle is adapted for air travel; and
the cooling fluid is air.

75. The method of claim 73, further comprising the step of bringing the first fluid into thermal communication with a heat exchanger, and wherein:
the heat exchanger is a convective heat exchanger cooling the first fluid by directing water over a heat sink to dissipate thermal energy from the heat sink;
the vehicle is adapted for water travel; and
the cooling fluid is air.

76. The method of claim 73, further comprising the step of bringing the first fluid into thermal communication with a heat exchanger, and wherein:
the heat exchanger is a convective heat exchanger cooling the first fluid by directing air over a heat sink to dissipate thermal energy from the heat sink;
the vehicle is adapted for land travel; and
the cooling fluid is air.

77. The method of claim 73, further comprising the step of bringing the first fluid into thermal communication with a heat exchanger, and wherein:
the heat exchanger is a conductive heat exchanger cooling the first fluid by direct contact between water and a heat sink to dissipate thermal energy from the heat sink;
the vehicle is adapted for water travel; and
the cooling fluid is air.

78. The method of claim 73, further comprising the steps of:
withdrawing the first fluid from a fluid reservoir before bringing the first fluid into thermal communication with the heating surfaces of the first and second bank of thermoelectric devices bringing the first fluid into thermal communication with a heat exchanger;
depositing the first fluid back into the fluid reservoir after bringing the first fluid into thermal communication with the heating surfaces of the first and second bank of thermoelectric devices; and, wherein,
the heat exchanger is a convective heat exchanger cooling the first fluid by directing air over a heat sink to dissipate thermal energy from the heat sink,
the vehicle is adapted for air travel, and
the cooling fluid is air.

79. A method of cooling a fluid comprising the steps of:
providing a first bank of thermoelectric devices having cooling surfaces capable of absorbing thermal energy and opposed heating surfaces capable of dissipating thermal energy;
positioning a first fluid conduit into thermal communication with the heating surfaces of the first bank of thermoelectric devices;
positioning a second fluid conduit within a second heat transfer block into thermal communication with the cooling surfaces of the first bank of thermoelectric devices;
providing electric current to the first bank of thermoelectric devices;
bringing a first fluid within the first fluid conduit into thermal communication with the heating surfaces of the first bank of thermoelectric devices; and
bringing a second fluid into thermal communication with the cooling surfaces of the first bank of thermoelectric devices.

80. The method of claim 79, wherein the second fluid is a vehicle lubricant.

81. The method of claim 79, wherein the second fluid is a gas directed to a combustion chamber of an internal combustion engine.

82. The method of claim 81, wherein the gas contains a potion of exhaust gas from a combustion process of the internal combustion engine.

83. The method of claim 79, wherein the step of positioning a first fluid conduit into thermal communication with the heating surfaces of the first bank of thermoelectric devices includes the step of positioning the first fluid conduit within a first heat transfer block, and wherein the first fluid conduit is a closed loop.

84. The method of claim 79, wherein the step of positioning a first fluid conduit into thermal communication with the heating surfaces of the first bank of thermoelectric devices includes the step of positioning the first fluid conduit within a first heat transfer block, and wherein the first fluid conduit is an open loop.

85. The method of claim 83, wherein:
the second block of heat transfer material is divided into at least two blocks;
the second fluid conduit within the second block of heat transfer material is oriented so as to inhibit laminar flow while within the second block of heat transfer material;
a ratio of the total heat capacity (J/° C.) of the heat transfer block compared to the volume (L) occupied by the second fluid while within the second block of heat transfer material is greater than 50.

86. A method of controlling the temperature of a liquid within a beverage dispenser, comprising the steps of:
providing a first bank of thermoelectric devices having cooling surfaces capable of absorbing thermal energy and opposed heating surfaces capable of dissipating thermal energy;
orienting a first fluid conduit in thermal communication with a first one of the cooling surfaces of the first bank of thermoelectric devices and heating surfaces of the first bank of thermoelectric devices;
orienting a second block of heat transfer material in concurrent thermal communication with a liquid within a beverage dispenser and with the first one of the heating and cooling surfaces of the first bank of thermoelectric devices;
providing electric current to the first bank of thermoelectric devices;
directing a first fluid within the first fluid conduit into the first block of heat transfer material;
directing the first fluid from the first block of heat transfer material to a heat exchanger; and
controlling the electric current provided to the first bank of thermoelectric devices.

87. The method of claim 86, wherein:
the second block of heat transfer material is in thermal communication with the cooling surfaces of the first bank of thermoelectric devices; and
the first fluid within the first fluid conduit is in thermal communication with the heating surfaces of the first bank of thermoelectric devices.

88. The method of claim 87, further comprising the steps of:
providing a second fluid conduit in concurrent thermal communication with the second block of heat transfer material and the liquid;
directing a second fluid through the second fluid conduit; and
directing airflow over at least a portion of the second fluid conduit, and subsequently, to the liquid.

89. The method of claim 88, further comprising the steps of:
detecting a temperature related to at least one of a temperature external to the beverage dispenser, a temperature internal to the beverage dispenser and the temperature of the liquid; and
switching the direction of the electric current provided to the first bank of thermoelectric devices if the detected temperature is below a predetermined threshold .

90. The method of claim 89, wherein the liquid is contained within a sealed container adapted to be opened for consumer consumption.

91. The method of claim 89, wherein the liquid is a component of a final beverage product.

92. The method of claim 88, further comprising the steps of:
providing a second bank of thermoelectric devices having cooling surfaces capable of absorbing thermal energy and opposed heating surfaces capable of dissipating thermal energy;
positioning the first fluid conduit in thermal communication with a first one of the cooling surfaces of the second bank of thermoelectric devices and the heating surfaces of the second bank of thermoelectric devices;
positioning the second block of heat transfer material in thermal communication with a second one of the heating of the second bank of thermoelectric devices and cooling surfaces of the second bank of thermoelectric devices;
providing electric current to the second bank of thermoelectric devices;
directing the first fluid within the first fluid conduit into the second block of heat transfer material;
directing the first fluid from the second block of heat transfer material to the heat exchanger; and
controlling the current provided to the second bank of thermoelectric devices.

93. The method of claim 92, wherein:
the second block of heat transfer material is in thermal communication with the cooling surfaces of the second bank of thermoelectric devices;
the first fluid within the first fluid conduit is in thermal communication with the heating surfaces of the second bank of thermoelectric devices; and
the step of controlling the current provided to the second bank of thermoelectric devices includes providing direct or alternating current to the second bank of thermoelectric devices.

94. The method of claim 93, further comprising the steps of:
providing a second fluid conduit in concurrent thermal communication with the second block of heat transfer material and the liquid; and
directing a second fluid through the second fluid conduit.

95. The method of claim 94, further comprising the step of switching the direction of the electric current provided to the second bank of thermoelectric devices if the detected temperature is below a predetermined threshold.

96. The method of claim 95, wherein the liquid is a contained within a sealed container adapted to be opened for consumer consumption.

97. The method of claim 95, wherein the liquid is a component of a final beverage product.

98. A method of controlling the temperature of a liquid within a beverage dispenser, comprising the steps of:
providing a first bank of thermoelectric devices having cooling surfaces capable of absorbing thermal energy and opposed heating surfaces capable of dissipating thermal energy;
positioning a first block of heat transfer material in concurrent thermal communication with a first fluid conduit and a first one of the cooling and heating surfaces of the first bank of thermoelectric devices;
positioning a second block of heat transfer material in concurrent thermal communication with a liquid within a beverage dispenser and with the first one of the heating and cooling surfaces of the first bank of thermoelectric devices;
providing electric current to the first bank of thermoelectric devices;
directing a first fluid within the first fluid conduit into the first block of heat transfer material;
directing the first fluid from the first block of heat transfer material to a heat exchanger; and
controlling the electric current provided to the first bank of thermoelectric devices.

99. The method of claim 98, wherein:
the first block of heat transfer material is in concurrent thermal communication with the first fluid conduit and the heating surfaces of the first bank of thermoelectric devices;
the second block of heat transfer material is in thermal communication with the cooling surfaces of the first bank of thermoelectric devices; and
the first fluid within the first fluid conduit is in thermal communication with the heating surfaces of the first bank of thermoelectric devices.

100. The method of claim 99, further comprising the steps of:
providing a second fluid conduit in concurrent thermal communication with the second block of heat transfer material and the liquid;
directing a second fluid through the second fluid conduit; and
directing airflow over at least a portion of the second fluid conduit, and subsequently, to the liquid.

101. The method of claim 100, further comprising the steps of:
detecting a temperature related to at least one of a temperature external to the beverage dispenser, a temperature internal to the beverage dispenser and the temperature of the liquid; and
switching the direction of the electric current provided to the first bank of thermoelectric devices if the detected temperature is below a predetermined threshold.

102. The method of claim 101, wherein the liquid is contained within a sealed container adapted to be opened for consumer consumption.

103. The method of claim 101, wherein the liquid is a component of a final beverage product.

104. The method of claim 100, further comprising the steps of:
providing a second bank of thermoelectric devices having cooling surfaces capable of absorbing thermal energy and opposed heating surfaces capable of dissipating thermal energy;
positioning the first block of heat transfer material in concurrent thermal communication with the first fluid conduit and a first one of the cooling surfaces and the heating surfaces of the second bank of thermoelectric devices;
positioning the second block of heat transfer material in thermal communication with a first one of the heating and cooling surfaces of the second bank of thermoelectric devices;
providing electric current to the second bank of thermoelectric devices;
directing the first fluid within the first fluid conduit into the second block of heat transfer material;
directing the first fluid from the second block of heat transfer material to the heat exchanger; and
controlling the current provided to the second bank of thermoelectric devices.

105. The method of claim 104, wherein:
the first block of heat transfer material is in concurrent thermal communication with the first fluid conduit and the heating surfaces of the second bank of thermoelectric devices;
the second block of heat transfer material is in thermal communication with the cooling surfaces of the second bank of thermoelectric devices;
the first fluid within the first fluid conduit is in thermal communication with the heating surfaces of the second bank of thermoelectric devices; and
the step of controlling the current provided to the second bank of thermoelectric devices includes providing direct or alternating current to the second bank of thermoelectric devices.

106. The method of claim 105, further comprising the steps of:
providing a second fluid conduit in concurrent thermal communication with the second block of heat transfer material and the liquid; and
directing a second fluid through the second fluid conduit.

107. The method of claim 106, further comprising the step of switching the direction of the electric current provided to the second bank of thermoelectric devices if the detected temperature is below a predetermined threshold.

108. The method of claim 107, wherein the liquid is a contained within a sealed container adapted to be opened for consumer consumption.

109. The method of claim 107, wherein the liquid is a component of a final beverage product.

110. A method of reducing the thermal energy of a fluid entering an engine, comprising the steps of:
providing a first bank of thermoelectric devices having cooling surfaces capable of absorbing thermal energy and opposed heating surfaces capable of dissipating thermal energy;
positioning a first fluid conduit in thermal communication with the heating surfaces of the first bank of thermoelectric devices;
positioning a second fluid conduit in thermal communication with the cooling surfaces of the first bank of thermoelectric devices;
providing electric current to the first bank of thermoelectric devices;
bringing a first fluid within the first fluid conduit into thermal communication with the heating surfaces of the first bank of thermoelectric devices; and
bringing a second fluid within the second fluid conduit into concurrent thermal communication with the cooling surfaces of the first bank of thermoelectric devices and a target fluid being directed to an engine.

111. The method of claim 110, wherein the first fluid is a vehicle fuel.

112. The method of claim 110, wherein the second fluid is a vehicle lubricant.

113. The method of claim 110, wherein the second fluid is a gas.

114. The method of claim 110, further comprising the step of directing the first fluid to a heat exchanger after passing the first fluid within thermal communication of the first bank of thermoelectric devices.

115. The method of claim 114, wherein the second fluid is brought into thermal communication with the target fluid being directed to the engine by the second fluid flowing through an in-line radiator, such that the target fluid passing through the radiator is decreased in thermal energy.

116. The method of claim 115, wherein:
the heat exchanger comprises:
a hot fluid reservoir,
a convective heat transfer device, and
a pump for pumping the first fluid from the hot fluid reservoir, through the convective heat transfer device and then into thermal communication with the heating surfaces of the first bank of thermoelectric devices;
the first fluid conduit and the second fluid conduit are closed loops; and
the first fluid conduit is mounted to or extends through a first block of heat transfer material in thermal communication with the heating surfaces of the first bank of thermoelectric devices; and
the second fluid conduit is mounted to or extends through a second block of heat transfer material in thermal communication with the cooling surfaces of the first bank of thermoelectric devices.

117. The method of claim 116, further comprising step of automatically controlling the electric current provided to the first bank of thermoelectric devices based upon information gathered from the target fluid upstream from the in-line radiator or downstream from the in-line radiator.

118. An apparatus for transferring thermal energy in relation to a lubricant of an internal combustion engine, the apparatus comprising:
a thermoelectric heat exchanger including:
at least one thermoelectric device concurrently absorbing thermal energy on a first surface and dissipating thermal energy on a second surface,
a lubricant conduit in thermal communication with the first surface, and
a heat sink in thermal communication with the second surface; and
a first pump in fluid communication with the lubricant conduit.

119. The apparatus of claim 118, further comprising a diverter adapted to divert lubricant from the internal combustion engine to the lubricant conduit.

120. The apparatus of claim 119, wherein the diverter is a lubricant filter extension mounted to a hot lubricant outlet of the lubricant filter, the diverter has a first lubricant outlet and a first lubricant inlet, the first lubricant outlet of the diverter directs the lubricant into the lubricant conduit to be cooled by the thermoelectric heat exchanger, and the first lubricant inlet of the diverter receives cooled lubricant from the thermoelectric heat exchanger.

121. The apparatus of claim 119, wherein the lubricant is directed in part by the first lubricant inlet of the diverter to a lubricant filter.

122. The apparatus of claim 119, wherein the diverter is mounted in series with a hot lubricant outlet of a vehicle lubrication system, the diverter has a first lubricant outlet and a first lubricant inlet, the first lubricant outlet of the diverter directs the lubricant into the cool fluid conduit to be cooled by the thermoelectric heat exchanger, and the first lubricant inlet of the diverter receives cooled lubricant.

123. The apparatus of claim 122, wherein the lubricant is directed in part by the first lubricant inlet of the diverter to a lubricant filter.

124. The apparatus of claim 118, wherein the heat sink is a convective heat sink that includes:
a finned block of heat transfer material; and
a means for providing convective currents in proximity to a surface of the finned block of heat transfer material.

125. The apparatus of claim 118, wherein the heat sink is a convective heat sink that includes:
a warm fluid conduit in thermal communication with the second surface of the thermoelectric device;
a radiator having a warm fluid inlet and a warm fluid outlet coupled to the warm fluid conduit; and
a second pump in fluid communication with the warm fluid conduit.

126. The apparatus of claim 125, wherein the heat sink includes a means for providing convective currents in proximity to the radiator.

127. The apparatus of claim 126, wherein the convective heat sink additionally comprises a warm fluid reservoir in fluid communication with the warm fluid conduit.

128. The apparatus of claim 127, wherein the radiator, the second pump, at least a portion of the warm fluid conduit and the fluid reservoir are mounted to a platform.

129. An apparatus for transferring thermal energy in relation to a gas flowing toward a combustion chamber of an internal combustion engine, the apparatus comprising:
a thermoelectric heat exchanger including:
at least one thermoelectric device concurrently absorbing thermal energy on a first surface and dissipating thermal energy on a second surface,
a gas conduit in thermal communication with the first surface, and
a heat sink in thermal communication with the second surface; and
a turbocharger in fluid communication with the gas conduit.

130. The apparatus of claim 129, further comprising a diverter adapted to divert a portion of a combustion gas from the internal combustion chamber into the gas conduit.

131. The apparatus of claim 129, wherein the turbocharger is downstream from the thermoelectric heat exchanger.

132. The apparatus of claim 129, wherein the turbocharger is upstream from the thermoelectric heat exchanger.

133. The apparatus of claim 129, wherein the gas conduit includes a mixer which mixes the combustion gas with the ambient gas within the gas conduit.

134. The apparatus of claim 129, wherein the heat sink is a convective heat sink that includes:
a finned block of heat transfer material; and
a means for providing convective currents in proximity to a surface of the finned block of heat transfer material.

135. The apparatus of claim 129, wherein the heat sink is a convective heat sink that includes:
a warm fluid conduit in thermal communication with the second surface of the thermoelectric device;
a radiator having a warm fluid inlet and a warm fluid outlet coupled to the warm fluid conduit; and
a second pump in fluid communication with the warm fluid conduit.

136. The apparatus of claim 135, wherein the heat sink includes a means for providing convective currents in proximity to the radiator.

137. The apparatus of claim 136, wherein the convective heat sink additionally comprises a warm fluid reservoir in fluid communication with the warm fluid conduit.

138. The apparatus of claim 137, wherein the radiator, the second pump, at least a portion of the warm fluid conduit and the fluid reservoir are mounted to a platform.

139. An apparatus for transferring thermal energy in relation to a fuel of an internal combustion engine, the apparatus comprising:
a thermoelectric heat exchanger including:
at least one thermoelectric device concurrently absorbing thermal energy on a first surface and dissipating thermal energy on a second surface,
a fuel conduit in thermal communication with one of the first surface and the second surface, and
a fluid conduit in thermal communication with one of the second surface and the first surface.

140. The apparatus of claim 139, further comprising:
a first heat exchanger in fluid communication with the fluid conduit including:
a first radiator, and
a first convective device; and
a fuel pump in fluid communication with the fuel conduit.

141. The apparatus of claim 140, wherein:
the fuel conduit is in thermal communication with the first surface;
the fluid conduit is in thermal communication with the second surface; and
the fluid conduit and the first heat exchanger are part of a closed loop.

142. The apparatus of claim 139, wherein:
the fuel conduit is in thermal communication with the second surface;
the fluid conduit is in thermal communication with the first surface;
the fuel conduit is a fuel tank; and
the fluid conduit and the first heat exchanger are part of a closed loop.

143. The apparatus of claim 139, wherein:
the fuel conduit is in thermal communication with the second surface;
the fluid conduit is in thermal communication with the first surface; and
the fluid conduit and the first heat exchanger are part of a closed loop.

144. A method of cooling fuel before entering an internal combustion engine, comprising the steps of:
activating a thermoelectric heat exchanger having at least one thermoelectric device dissipating thermal energy on a first surface and absorbing thermal energy on a second surface;
orienting a fuel conduit so as to be in thermal communication with the first surface of the thermoelectric device;
directing fuel through the fuel conduit, thereby decreasing the thermal energy of the fuel;
orienting a warm fluid conduit so as to be in thermal communication with the second surface of the thermoelectric device;
directing the warm fluid through the warm fluid conduit, thereby increasing the thermal energy of the warm fluid;
directing the warm fluid through a conventional heat exchanger so as to reduce the thermal energy of the warm fluid; and
cycling the warm fluid between the conventional heat exchanger and the thermoelectric heat exchanger.

145. A method of heating fuel before entering an internal combustion engine, comprising the steps of:
activating a thermoelectric heat exchanger having at least one thermoelectric device dissipating thermal energy on a first surface and absorbing thermal energy on a second surface;
positioning a fuel conduit so as to be in thermal communication with the second surface of the thermoelectric device;
directing fuel through the fuel conduit, thereby increasing the thermal energy of the fuel;
positioning a warm fluid conduit so as to be in thermal communication with the first surface of the thermoelectric device;
directing the warm fluid through the warm fluid conduit, thereby decreasing the thermal energy of the warm fluid;
directing the warm fluid through a conventional heat exchanger so as to increase the thermal energy of the warm fluid; and
cycling the warm fluid between the conventional heat exchanger and the thermoelectric heat exchanger.

146. An engine lubricant cooling system for a vehicle comprising:
a vehicle engine lubricant conduit;
a first block of heat transfer material in thermal communication with the vehicle engine lubricant conduit;
a second block of heat transfer material; and
at least one thermoelectric device having a cooling surface that absorbs thermal energy when activated and an opposed heating surface that transmits thermal energy when activated, the thermoelectric device being positioned between the first and second blocks of heat transfer material such that the cooling surface faces and is in thermal communication with the first block of heat transfer material and such that the heating surface faces and is in thermal communication with the second block of heat transfer material.

147. The engine lubricant cooling system of claim 146, further comprising:
a heat dissipation fluid conduit in thermal communication with the second block of heat transfer material; and
means for dissipating heat from fluid flowing through the heat dissipation fluid conduit.

148. The engine lubricant cooling system of claim 147, wherein the heat dissipating means includes a radiator coupled in fluid communication with the heat dissipation fluid conduit.

149. The engine lubricant cooling system of claim 147, wherein the heat dissipating means includes:
a third block of heat transfer material in thermal communication with the heat dissipation fluid conduit, the third block including a plurality of heat dissipation projections; and
a flowing air source directed over the heat dissipation projections.

150. The engine lubricant cooling system of claim 147, wherein the heat dissipation fluid conduit is a vehicle fuel conduit.

151. The engine lubricant cooling system of claim 146, wherein the vehicle engine lubricant conduit extends through the first block of heat transfer material.

152. The engine lubricant cooling system of claim 151, wherein the vehicle engine lubricant conduit extends through the first block of heat transfer material in a serpentine pattern.

153. The engine lubricant cooling system of claim 151, wherein the vehicle engine lubricant conduit extends through the first block of heat transfer material in at least two paths.

154. The engine lubricant cooling system of claim 146, comprising a plurality the thermoelectric devices, each of which being positioned between the first and second blocks of heat transfer material such that their cooling surfaces face and are in thermal communication with the first block of heat transfer material and such that their heating surfaces face and are in thermal communication with the second block of heat transfer material.

155. The engine lubricant cooling system of claim 146, wherein the second block of heat transfer material is in thermal communication with a vehicle engine fuel.

156. The engine lubricant cooling system of claim 146, wherein the vehicle engine lubricant conduit is coupled and in fluid communication with a diverter valve, which is, in turn, coupled to and in fluid communication with a primary engine lubricant source.

157. The engine lubricant cooling system of claim 156, wherein the diverter valve is coupled to a lubricant filter.

158. An engine air stream cooling system for a vehicle comprising:
a coolant liquid conduit;
a first block of heat transfer material in thermal communication with the coolant liquid conduit;
a second block of heat transfer material;
at least one thermoelectric device having a cooling surface that absorbs thermal energy when activated and an opposed heating surface that transmits thermal energy when activated, the thermoelectric device being positioned between the first and second blocks of heat transfer material such that the cooling surface faces and is in thermal communication with the first block of heat transfer material and such that the heating surface faces and is in thermal communication with the second block of heat transfer material; and
means for transferring thermal energy from a vehicle engine air stream to the coolant liquid conduit.

159. The engine air stream cooling system of claim 158, wherein the thermal energy transferring means includes a radiator, which includes:
a coolant fluid inlet and a coolant fluid outlet coupled in series with the coolant liquid conduit; and
a plurality of fins positioned in the vehicle engine air stream.

160. The engine air stream cooling system of claim 158, wherein the vehicle engine air stream is contained within an air conduit.

161. The engine air stream cooling system of claim 160, wherein the air conduit is coupled to a turbo-charger.

162. The engine air stream cooling system of claim 158, wherein the coolant fluid conduit extends through the first block of heat transfer material.

163. The engine air stream cooling system of claim 162, wherein the coolant fluid conduit extends through the first block of heat transfer material in a serpentine pattern.

164. The engine air stream cooling system of claim 162, wherein the coolant fluid conduit extends through the first block of heat transfer material in at least two paths.

165. The engine air stream cooling system of claim 158, wherein the vehicle engine air stream is fed to a combustion section of the vehicle.

166. The engine air stream cooling system of claim 158, wherein the vehicle engine air stream is fed to a turbo-charger.

167. The engine air stream cooling system of claim 166, wherein the thermal energy transfer means is positioned upstream from the turbo-charger.

168. The engine air stream cooling system of claim 166, wherein the thermal energy transfer means is positioned downstream from the turbo-charger.

169. A method for cooling an engine lubricant, comprising the steps of:
positioning a heat-exchanger assembly in line with a vehicle engine lubricant conduit, the heat-exchanger assembly including,
at least a first block of heat transfer material in thermal communication with the vehicle engine lubricant conduit;
at least one thermoelectric device having a cooling surface that absorbs thermal energy when activated and an opposed heating surface that transmits thermal energy when activated, the thermoelectric device being positioned such that the cooling surface faces and is in thermal communication with the first block of heat transfer material; and
activating the thermoelectric device such that heat is transferred from engine lubricant flowing through the vehicle engine lubricant conduit and into the cooling surface of the thermoelectric device.

170. The method of claim 169, wherein the positioning step includes the step of extending the vehicle engine lubricant conduit through the first block of heat transfer material.

171. The method of claim 170, wherein the vehicle engine lubricant conduit is extended through the first block of heat transfer material, in the extending step, in a serpentine pattern.

172. The method of claim 170, wherein the vehicle engine lubricant conduit is extended through the first block of heat transfer material, in the extending step, in at least two paths.

173. The method of claim 169, wherein:
the heat-exchanger assembly includes a plurality of thermoelectric devices, each having a cooling surface that absorbs thermal energy when activated and an opposed heating surface that transmits thermal energy when activated, the thermoelectric devices being positioned such that the cooling surfaces face and are in thermal communication with the first block of heat transfer material; and
the activating step includes the step of activating the plurality of thermoelectric devices.

174. The method of claim 169, wherein:
the heat-exchanger assembly further includes a second block of heat transfer material facing and in thermal communication with the heating surface of the thermoelectric device, and includes a heat dissipation conduit in thermal communication with the second block of heat transfer material; and
the method further comprises the step of dissipating heat from the heat dissipation fluid conduit.

175. The method of claim 174, wherein the dissipating step is performed, at least in part, by a radiator coupled in series with the heat dissipation fluid conduit.

176. The method of claim 175, further comprising the step of circulating heat dissipation fluid through the heat dissipation fluid conduit.

177. The method of claim 174, wherein:
the heat dissipation fluid conduit extends through a third block of heat transfer material, the third block of heat transfer material including a plurality of heat-dissipation projections; and
the dissipating step includes a step of directing an air flow over the heat-dissipation projections of the third block of heat transfer material.

178. The method of claim 177, further comprising the step of circulating heat dissipation fluid through the heat dissipation fluid conduit.

179. A method for cooling an air stream directed into at least one of a vehicle turbo charger and a vehicle engine combustion section, comprising the steps of:
providing a heat-exchanger assembly with a vehicle, the heat-exchanger assembly including:
a first block of heat transfer material;
at least one thermoelectric device having a cooling surface that absorbs thermal energy when activated and an opposed heating surface that transmits thermal energy when activated, the thermoelectric device being positioned such that the cooling surface faces and is in thermal communication with the first block of heat transfer material; and
a coolant fluid conduit in thermal communication with the first block of heat transfer material;
circulating a coolant fluid through the coolant fluid conduit;
transferring thermal energy from an air stream, directed into at least one of a vehicle turbo charger and a vehicle engine combustion section, to the coolant fluid circulating through the coolant fluid conduit; and
activating the thermoelectric device to transfer thermal energy from the coolant fluid circulating through the coolant fluid conduit and into the cooling surface of the thermoelectric device.

180. The method of claim 179, wherein the step of transferring thermal energy from the air stream to the coolant fluid circulating through the coolant fluid conduit includes the step of coupling the coolant fluid conduit in series with an inlet and an outlet of a radiator positioned within the air stream.

181. The method of claim 179, wherein the step of transferring thermal energy from the air stream to the coolant fluid circulating through the coolant fluid conduit includes the step of extending the coolant fluid conduit through a second block of heat transfer material positioned in the air stream.

182. The method of claim 181, wherein the second block of heat transfer material includes a plurality of projections.

183. The method of claim 179, wherein the coolant fluid conduit extends through the first block of heat transfer material.

184. The method of claim 183, wherein the coolant fluid conduit extends through the first block of heat transfer material in a serpentine pattern.

185. The method of claim 183, wherein the coolant fluid conduit extends through the first block of heat transfer material in at least two paths.

186. The method of claim 179, wherein:
the heat-exchanger assembly includes a plurality of thermoelectric devices, each having a cooling surface that absorbs thermal energy when activated and an opposed heating surface that transmits thermal energy when activated, the thermoelectric devices being positioned such that the cooling surfaces face and are in thermal communication with the first block of heat transfer material; and
the activating step includes the step of activating the plurality of thermoelectric devices.

187. The method of claim 179, wherein:
the heat-exchanger assembly further includes a second block of heat transfer material facing and in thermal communication with the heating surface of the thermoelectric device, and includes a heat dissipation conduit in thermal communication with the second block of heat transfer material; and
the method further comprises the steps of,
circulating a heat dissipation fluid through the head dissipating fluid conduit; and
dissipating heat from the heat dissipation fluid circulating through the heat dissipation fluid conduit.

188. The method of claim 187, wherein the dissipating step is performed, at least in part, by a radiator coupled in series with the heat dissipation fluid conduit.

189. The method of claim 187, wherein:
the heat dissipation fluid conduit extends through a third block of heat transfer material, the third block of heat transfer material including a plurality of heat-dissipation projections; and
the dissipating step includes a step of directing an air flow over the heat-dissipation projections of the third block of heat transfer material.
